(19) United States
(12) Patent Application Publication
(10) Pub. No.: US 2024/0134341 A1
(43) Pub. Date: Apr. 25, 2024

(54) ANALYTICS FOR ABRASIVE PRODUCTS AND PROCESSES

(71) Applicants: SAINT-GOBAIN ABRASIVES, INC., Worcester, MA (US); SAINT-GOBAIN ABRASIFS, Conflans-Sainte-Honorine (FR)

(72) Inventors: Sujatha K. IYENGAR, Northborough, MA (US); Rajappa TADEPALLI, Chennai (IN); Atin ANGRISH, Northborough, MA (US); Grace O. OLATILU, Somerset, NJ (US); Siddarth SRINIVASAN, Cambridge, MA (US); Kenneth A. SAUCIER, Leicester, MA (US); Christopher M. FITZGERALD, Arlington Heights, IL (US); Brian P. RUTKIEWICZ, Worcester, MA (US); Alfredo Omar BARRAGAN, Shrewsbury, MA (US); Robin M. BRIGHT, Charlton, MA (US)

(21) Appl. No.: 18/566,298

(22) PCT Filed: May 31, 2022
(86) PCT No.: PCT/US2022/072678

§ 371 Date: Dec. 1, 2023

Related U.S. Application Data
(60) Provisional application No. 63/196,642, filed on Jun. 3, 2021.

(51) Int. Cl. G05B 19/4065; B24B 49/00

(52) U.S. Cl. CPC G05B 19/4065; B24B 49/00; G05B 2219/37252

(57) ABSTRACT

The present application relates to systems and methods for obtaining real-time abrasion data. An example computer-implemented method could include receiving, at a computing device, sensor data from one or more sensors. The one or more sensors are disposed in proximity to an abrasive product or a workpiece associated with the abrasive product. The one or more sensors are configured to collect abrasion operational data associated with an abrasive operation involving the abrasive product or the workpiece. The computer-implemented method could further include training, based on the sensor data, a machine learning system to determine product specific information of the abrasive product and/or workpiece specific information. The computer-implemented method could also include providing the trained machine learning system using the computing device.

### BACKGROUND ART

Abrasive tools can be used in various material removal operations. Such tools have been equipped with sensors that may monitor the usage of the tools. For example, a power sensor may be incorporated into a tool in order to monitor the electrical power that is consumed by the load. Although a power sensor incorporated into the tool may provide a user of the tool with useful information related to the tool, the sensor may not fully capture the operation of the tool and/or the experience of the user. For example, power sensor data cannot effectively be used to determine whether a component of the tool has been damaged or is malfunctioning.

### SUMMARY

The present disclosure generally relates to systems and methods for obtaining, analyzing, and utilizing real-time data in abrasive and abrasive device applications.

In a first aspect, a computer-implemented method is provided. The computer-implemented method includes receiving, at the computing device, sensor data from one or more sensors. The one or more sensors are disposed in proximity to an abrasive product or a workpiece associated with the abrasive product and the one or more sensors are configured to collect abrasion operational data associated with an abrasive operation involving the abrasive product or the workpiece. The computer-implemented method also includes performing at least one of the following operations (i) receiving, at the computing device, a user input indicating an organization of data; determining, based on the sensor data, a machine downtime report; based on the user input, organizing the machine downtime report; determining, from the sensor data, an operator efficiency report, (ii) in response to receiving the sensor data, determining an operation metrics report, (iii) selecting data organization types, (iv) receiving, at the computing device, a user input indicating a data organization type, which includes by machine, by operator, or by process; determining, based on the sensor data and a data organization type, a setup time report, (v) determining, based on the sensor data, a shift variation report, and (vi) determining, based on the sensor data, a machine comparison report. The machine comparison report provides information indicative of similar processes occurring on different machines. The shift variation report provides information indicative of metric variations across a plurality of work shift. The computer-implemented method further includes displaying, on the computing device, at least one displayed report. The displayed report comprises at least one of the downtime report, the operation metrics report, a setup time report, a shift variation report, or a machine comparison report.

In a second aspect, a computer-implemented method is provided. The computer-implemented method includes receiving, at the computing device, sensor data from one or more sensors. The one or more sensors are disposed in proximity to an abrasive product or a workpiece associated with the abrasive product and the one or more sensors are configured to collect abrasion operational data associated with an abrasive operation involving the abrasive product or the workpiece. The computer-implemented method further includes performing at least one of the following operations: (i) displaying, on the computing device, a cycle chart plotting at least one grinding cycle corresponding to a time range or a machine and displaying, at the computing device, the cycle chart, (ii) determining, based on the sensor data, a grinding cycle report relating to the analysis of at least one portion of a grinding cycle and displaying, at the computing device, the grinding cycle report, (iii) determining, based on the sensor data, a computed metric report having values of various metrics. The values include an average and at least one local maxima and displaying, at the computing device, the computed metric report.

In a third aspect, a computer-implemented method is provided. The computer-implemented method includes receiving, at the computing device, sensor data from one or more sensors. The one or more sensors are disposed in proximity to an abrasive product or a workpiece associated with the abrasive product and the one or more sensors are configured to collect abrasion operational data associated with an abrasive operation involving the abrasive product or the workpiece. The computer-implemented method further includes performing at least one of the following operations: (i) determining, based on the sensor data, a variation report, (ii) determining, based on the sensor data, an anomaly report and displaying, on the computing device, an output report. The variation report includes information indicative of a variation within a process or a workpiece and displaying, on the computing device and the variation report the anomaly report includes information indicative of anomalies within a process using at least one unsupervised machine learning method. The output report comprises the variation report or the anomaly report.

In a fourth aspect, a computer-implemented method is provided. The computer-implemented method includes receiving, at the computing device, sensor data from one or more sensors. The one or more sensors are disposed in proximity to an abrasive product or a workpiece associated with the abrasive product and the one or more sensors are configured to collect abrasion operational data associated with an abrasive operation involving the abrasive product or the workpiece. The computer-implemented method further includes performing at least one of the following operations: (i) displaying, on the computing device, a plurality of datasets from the sensor data and determining a part production quality trend, (ii) determining, based on sensor data, a grinding wheel life and displaying, on the computing device, the grinding wheel life, (iii) determining, based on the sensor data, an optimum feed rate and an part cycle time, and displaying, on the computing device, at least one of the optimum feed rate and the part cycle time, (iv) determining, based on the sensor data, a sparkout time and displaying, on the computing device, the sparkout time. The grinding wheel life corresponds to an amount of time prior to redressing or a wheel replacement is needed. A machine configured to use the optimum feed rate and part will minimize grinding wheel wear.

In a fifth aspect, a computer-implemented method is provided. The computer-implemented method includes receiving, at the computing device, sensor data from one or more sensors. The one or more sensors are disposed in proximity to an abrasive product or a workpiece associated with the abrasive product and the one or more sensors are configured to collect abrasion operational data associated with an abrasive operation involving the abrasive product or the workpiece. The computer-implemented method further includes determining, based on the sensor data, a product recommendation list. The computer-implemented method also includes displaying, on the computing device, the product recommendation list. In a sixth aspect, a computer-implemented method is provided. The computer-implemented method includes receiving, at the computing device, sensor data from one or more sensors. The one or more sensors are disposed in proximity to an abrasive product or a workpiece associated with the abrasive product and the one or more sensors are configured to collect abrasion operational data associated with an abrasive operation involving the abrasive product or the workpiece. The computer-implemented method further includes determining, based on sensor data, a natural frequency associated with a grinding wheel or a part of a grinding wheel. The computer-implemented method further includes determining, based on sensor data, a frequency associated with the grinding wheel or part of a grinding wheel. The computer-implemented method also includes determining whether an issue exists with the grinding wheel by comparing the natural frequency and the frequency.

In a seventh aspect, a computer-implemented method is provided. The computer-implemented method includes receiving, at the computing device, sensor data from one or more sensors. The one or more sensors are disposed in proximity to an abrasive product or a workpiece associated with the abrasive product and the one or more sensors are configured to collect abrasion operational data associated with an abrasive operation involving the abrasive product or the workpiece. The computer-implemented method further includes determining, based on the sensor data, at least one of the following: a dress count, a dress frequency, a total dress time, and an indicator of dressing.

In an eighth aspect, a computer-implemented method is provided. The computer-implemented method includes receiving, at the computing device, sensor data from one or more sensors. The one or more sensors are disposed in proximity to an abrasive product or a workpiece associated with the abrasive product and the one or more sensors are configured to collect abrasion operational data associated with an abrasive operation involving the abrasive product or the workpiece. The computer-implemented method further includes determining, based on sensor data, a grinding wheel life. The grinding wheel life corresponds to an amount of time prior to redressing or a wheel replacement is needed. The computer-implemented method also includes displaying, on the computing device, the grinding wheel life. In a ninth aspect, a computer-implemented method is provided. The computer-implemented method includes receiving, at the computing device, sensor data from one or more sensors. The one or more sensors are disposed in proximity to an abrasive product or a workpiece associated with the abrasive product and the one or more sensors are configured to collect abrasion operational data associated with an abrasive operation involving the abrasive product or the workpiece. The computer-implemented method further includes determining a tool inventory database. The computer-implemented method also includes determining, based on the sensor data, usage data of one or more tools in the tool inventory database. The computer-implemented method also includes determining an approximate additional number needed of the one or more tools.

In a tenth aspect, a computer-implemented method is provided. The computer-implemented process includes receiving, at the computing device, sensor data from one or more sensors. The one or more sensors are disposed in proximity to an abrasive product or a workpiece associated with the abrasive product and the one or more sensors are configured to collect abrasion operational data associated with an abrasive operation involving the abrasive product or the workpiece. The computer implemented process further includes performing at least one of the following operations: (i) determining one or more company statuses, (ii) designating, based on one or more user inputs, one or more companies as favorited companies and displaying one or more updates corresponding to the one or more favorited companies, (iii) determining one or more market trends and displaying the one or more market trends.

In an eleventh aspect, a computer-implemented method is provided. The computer-implemented process includes receiving, at the computing device, sensor data from one or more sensors. The one or more sensors are disposed in proximity to an abrasive product or a workpiece associated with the abrasive product and the one or more sensors are configured to collect abrasion operational data associated with an abrasive operation involving the abrasive product or the workpiece. The computer-implemented process also includes performing at least one of the following operations: (i) determining, based on the sensor data, a fault analysis, (ii) determining, based on the sensor data, one or more collisions, (iii) determining, based on the sensor data, bearing noise.

In a twelfth aspect, a computer implemented method is provided. The computer-implemented process includes receiving, at the computing device, sensor data from one or more sensors. The one or more sensors are disposed in proximity to an abrasive product or a workpiece associated with the abrasive product and the one or more sensors are configured to collect abrasion operational data associated with an abrasive operation involving the abrasive product or the workpiece. The computer-implemented method further includes determining, based on the sensor data, a cost reduction. The cost reduction corresponds to one of the following changes: one or more purchases of one or more new products or one or more changes in cycle optimizations. The computer-implemented method also includes displaying the cost reduction.

In a thirteenth aspect, a computer-implemented method is presented. The computer-implemented method includes receiving, at the computing device, sensor data from one or more sensors. The one or more sensors are disposed in proximity to an abrasive product or a workpiece associated with the abrasive product and the one or more sensors are configured to collect abrasion operational data associated with an abrasive operation involving the abrasive product or the workpiece. The computer-implemented method further includes determining, based on sensor data and information stored in a database, whether to distribute work among one or more additional enterprises.

In a fourteenth aspect, a computer-implemented method is presented. The computer-implemented method includes receiving, at the computing device, sensor data from one or more sensors. The one or more sensors are disposed in proximity to an abrasive product or a workpiece associated with the abrasive product. The one or more sensors are configured to collect abrasion operational data associated with an abrasive operation involving the abrasive product or the workpiece. The computer-implemented method further includes performing at least one of the following operations: (i) determining, based on the sensor data, efficiency improvements and displaying, on the computing device, the efficiency improvements, (ii) determining, based on the sensor data, energy input and energy output and displaying, on the computing device, the energy input and the energy output, (iii) determining, based on the sensor data, abnormal vibrations and displaying, on the computing device, a suggested action in response to the abnormal vibrations.

### BRIEF DESCRIPTION OF THE DRAWINGS

FIG. 1A includes a perspective view illustration of a shaped abrasive particle, according to an example embodiment.

FIG. 1B includes a top-down illustration of the shaped abrasive particle of FIG. 1A, according to an example embodiment.

FIG. 1C includes a perspective view illustration of a shaped abrasive particle, according to an example embodiment.

FIG. 2A includes a perspective view illustration of a controlled height abrasive particle (CHAP), according to an example embodiment.

FIG. 2B includes a perspective view illustration of a non-shaped particle, according to an example embodiment.

FIG. 3 includes a cross-sectional illustration of a coated abrasive article incorporating particulate material, according to an example embodiment.

FIG. 4 includes a top view of a portion of a coated abrasive, according to an example embodiment.

FIG. 5 illustrates a cross-sectional of a portion of a coated abrasive, according to an example embodiment.

FIG. 6 includes a perspective view illustration of a bonded abrasive article, according to an example embodiment.

FIG. 7A illustrates a cross-sectional view of an abrasive article, according to an example embodiment.

FIG. 7B illustrates a cross-sectional view of an electronic assembly, according to an example embodiment.

FIG. 8A illustrates a top-down view of a releasable coupling of an electronic assembly on a body, according to an example embodiment.

FIG. 8B illustrates an abrasive system, according to an example embodiment.

FIGS. 9A-9C illustrate microscopic interactions, according to an example embodiment.

FIG. 10 illustrates a block diagram of a computing device, according to an example embodiment.

FIG. 11A illustrates an arrangement of an analytics platform, according to an example embodiment.

FIG. 11B illustrates internal communications of an analytics platform, according to an example embodiment.

FIG. 12 illustrates a manufacturing metrics panel, according to an example embodiment.

FIG. 13 illustrates a cycle and grinding analytics panel, according to an example embodiment.

FIG. 14 illustrates a statistical process control panel, according to an example embodiment.

FIG. 15 illustrates a cycle optimization panel, according to an example embodiment.

FIG. 16 illustrates an abrasive product sales panel, according to an example embodiment.

FIG. 17 illustrates a vibration and chatter panel, according to an example embodiment.

FIG. 18 illustrates a dressing panel, according to an example embodiment.

FIG. 19 illustrates a wheel life panel, according to an example embodiment.

FIG. 20 illustrates a wheel management panel, according to an example embodiment.

FIG. 21 illustrates a bellwether analytics panel, according to an example embodiment.

FIG. 22 illustrates a machine health panel, according to an example embodiment.

FIG. 23 illustrates an economics panel, according to an example embodiment.

FIG. 24 illustrates a distributed manufacturing panel, according to an example embodiment.

FIG. 25 illustrates an environmental health and safety optimization panel, according to an example embodiment.

FIG. 26 illustrates a remote application engineering panel, according to an example embodiment.

### DETAILED DESCRIPTION OF THE PREFERRED EMBODIMENT(S)

Example methods, devices, and systems are described herein. It should be understood that the words “example” and “exemplary” are used herein to mean “serving as an example, instance, or illustration.” Any embodiment or feature described herein as being an “example” or “exemplary” is not necessarily to be construed as preferred or advantageous over other embodiments or features. Other embodiments can be utilized, and other changes can be made, without departing from the scope of the subject matter presented herein.

Thus, the example embodiments described herein are not meant to be limiting. Aspects of the present disclosure, as generally described herein, and illustrated in the figures, can be arranged, substituted, combined, separated, and designed in a wide variety of different configurations, all of which are contemplated herein.

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment.

### I. Overview

Abrasive products are used extensively in a wide variety of industrial and domestic operations, ranging from home improvement projects to highly technical precision engineering. With the assistance of these products, operators can perform grinding, polishing, buffing, and other operations to shape and surface-finish many different types of materials.

Often, an abrasive product manufacturer collects operational data from customers to improve the productivity and safety of their abrasive products. For instance, a manufacturer can equip an abrasive product with sensors to generate data streams on inputs (e.g., components that form the product), operations (e.g., the power, speed, and/or vibration of the product), and outputs (e.g., the end-material surface-finish) of the abrasive product. By combining multiple data streams, for example, through Internet of Things (IoT) aggregation tools, the manufacturer can acquire diagnostic information from a wide range of abrasive products, enhancing the manufacturer's ability to perform process monitoring, address customer issues, and improve the development of future abrasive products.

To provide further value, it may be beneficial for the manufacturer to convert diagnostic information into a form easily usable for customers. For example, given that a customer can be an enterprise, a production manager from the enterprise may be concerned with productivity and quality information of an abrasive product, whereas an operator from the enterprise may be concerned with real-time safety information. As such, it may be advantageous for the manufacturer to convert the diagnostic information into a text notification and transmit the notification to graphical interfaces used by the production manager and operator.

To efficiently convert and transmit the diagnostic information, the manufacturer may benefit from a remotely-hosted platform that can understand the individuals/entities operating within the enterprise and distribute, in real-time, diagnostic information to the relevant individuals/entities. The goal of such a platform would be to develop a predictive intelligence and analytical framework for a customer's procedures so that the customer can focus on producing high-value materials with the products rather than wasting time analyzing abrasive product data.

In order to achieve this goal, a machine learning platform is described herein, which may intelligently provide predictive analytics to customers of an abrasive product manufacturer. Such a machine learning platform can be hosted remotely from customers, but may access data and services from the customers by way of secure connections. The machine learning platform may be web-based and accessible from a variety of Internet-enabled client devices. For example, the machine learning platform could have a mobile applications component (iOS/Android) and a web services component that allows customers to easily access the features provided by the platform.

Such a machine learning platform may have several desirable capabilities and characteristics. For example, by utilizing aggregate diagnostic information across multiple customers, the machine learning platform can develop deep insights that provide real-time feedback to recommend and/or adjust customer operations and forecasted statistics in real-time to drive a customer's future business decisions. These characteristics of the machine learning platform may also be leveraged by the manufacturer to develop new business models, including abrasive services and abrasive products, thereby driving further growth for the manufacturer. Other features, functionality, and benefits of such a machine learning platform may exist and will be appreciated and understood from the discussion below.

Accordingly, disclosed herein are methods and systems for using abrasive operational data indicative of a behavior of an abrasive product. As described herein, the abrasive operational data could be sent to a machine learning platform to train one or more machine learning models. Each machine learning model may be configured to predict one or more behaviors of an abrasive product based on the abrasive operational data. The machine learning platform may transmit to the interface on the abrasive product, to a mobile computing device, or to an analytics platform product-specific information or workpiece-specific information related to the abrasive product. This information may include providing ergonomic recommendations to an operator using the product, determining the end of life of the product, and/or determining operational improvements (e.g., workflow best practices).

### II. Example Abrasive Particles

As used herein, the term abrasive tool includes any tool configured to be used with an abrasive article. An abrasive article can include a fixed abrasive article including at least a substrate and abrasive particles connected to (e.g., contained within or overlying) the substrate. The abrasive articles of the embodiments herein can be bonded abrasives, coated abrasive, non-woven abrasives, thin wheels, cut-off wheels, reinforced abrasive articles, superabrasives, single-layered abrasive articles and the like. Such abrasive articles can include one or more various types of abrasive particles, including for example, but not limited to, shaped abrasive particles, constant height abrasive particles, unshaped abrasive particles (e.g., crushed, extruded, or exploded abrasive particles) and the like.

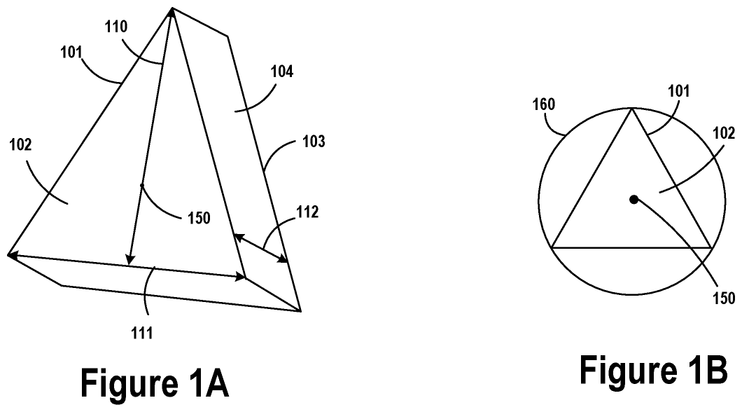

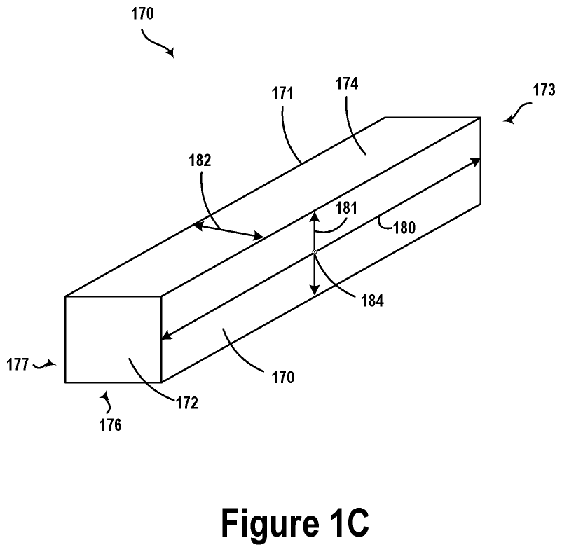

FIG. 1A includes a perspective view illustration of a shaped abrasive particle in accordance with an embodiment. The shaped abrasive particle 100 can include a body 101 including a major surface 102, a major surface 103, and a side surface 104 extending between the major surfaces 102 and 103. As illustrated in FIG. 1A, the body 101 of the shaped abrasive particle 100 can be a thin-shaped body, wherein the major surfaces 102 and 103 are larger than the side surface 104. Moreover, the body 101 can include a longitudinal axis 110 extending from a point to a base and through the midpoint 150 on a major surface 102 or 103. The longitudinal axis 110 can define the longest dimension of the body along a major surface and through the midpoint 150 of the major surface 102.

In certain particles, if the midpoint of a major surface of the body is not readily apparent, one may view the major surface top-down, draw a closest-fit circle around the two-dimensional shape of the major surface and use the center of the circle as the midpoint of the major surface.

FIG. 1B includes a top-down illustration of the shaped abrasive particle of FIG. 1A. Notably, the body 101 includes a major surface 102 having a triangular two-dimensional shape. The circle 160 is drawn around the triangular shape to facilitate location of the midpoint 150 on the major surface 102.

Referring again to FIG. 1A, the body 101 can further include a lateral axis 111 defining a width of the body 101 extending generally perpendicular to the longitudinal axis 110 on the same major surface 102. Finally, as illustrated, the body 101 can include a vertical axis 112, which in the context of thin shaped bodies can define a height (or thickness) of the body 101. For thin-shaped bodies, the length of the longitudinal axis 110 is greater than the vertical axis 112. As illustrated, the thickness along the vertical axis 112 can extend along the side surface 104 between the major surfaces 102 and 103 and perpendicular to the plane defined by the longitudinal axis 110 and lateral axis 111. It will be appreciated that reference herein to length, width, and height of the abrasive particles may be reference to average values taken from a suitable sampling size of abrasive particles of a larger group, including for example, a group of abrasive particle affixed to a fixed abrasive.

The shaped abrasive particles of the embodiments herein, including thin shaped abrasive particles can have a primary aspect ratio of length:width such that the length can be greater than or equal to the width. Furthermore, the length of the body 101 can be greater than or equal to the height. Finally, the width of the body 101 can be greater than or equal to the height. In accordance with an embodiment, the primary aspect ratio of length:width can be at least 1:1, such as at least 1.1:1, at least 1.2:1, at least 1.5:1, at least 1.8:1, at least 2:1, at least 3:1, at least 4:1, at least 5:1, at least 6:1, or even at least 10:1. In another non-limiting embodiment, the body 101 of the shaped abrasive particle can have a primary aspect ratio of length:width of not greater than 100:1, not greater than 50:1, not greater than 10:1, not greater than 6:1, not greater than 5:1, not greater than 4:1, not greater than 3:1, not greater than 2:1, or even not greater than 1:1. It will be appreciated that the primary aspect ratio of the body 101 can be within a range including any of the minimum and maximum ratios noted above.

However, in certain other embodiments, the width can be greater than the length. For example, in those embodiments wherein the body 101 is an equilateral triangle, the width can be greater than the length. In such embodiments, the primary aspect ratio of length:width can be at least 1:1.1 or at least 1:1.2 or at least 1:1.3 or at least 1:1.5 or at least 1:1.8 or at least 1:2 or at least 1:2.5 or at least 1:3 or at least 1:4 or at least 1:5 or at least 1:10. Still, in a non-limiting embodiment, the primary aspect ratio length:width can be not greater than 1:100 or not greater than 1:50 or not greater than 1:25 or not greater than 1:10 or not greater than 5:1 or not greater than 3:1. It will be appreciated that the primary aspect ratio of the body 101 can be within a range including any of the minimum and maximum ratios noted above.

Furthermore, the body 101 can have a secondary aspect ratio of width:height that can be at least 1:1, such as at least 1.1:1, at least 1.2:1, at least 1.5:1, at least 1.8:1, at least 2:1, at least 3:1, at least 4:1, at least 5:1, at least 8:1, or even at least 10:1. Still, in another non-limiting embodiment, the secondary aspect ratio width:height of the body 101 can be not greater than 100:1, such as not greater than 50:1, not greater than 10:1, not greater than 8:1, not greater than 6:1, not greater than 5:1, not greater than 4:1, not greater than 3:1, or even not greater than 2:1. It will be appreciated the secondary aspect ratio of width:height can be within a range including any of the minimum and maximum ratios of above.

In another embodiment, the body 101 can have a tertiary aspect ratio of length:height that can be at least 1.1:1, such as at least 1.2:1, at least 1.5:1, at least 1.8:1, at least 2:1, at least 3:1, at least 4:1, at least 5:1, at least 8:1, or even at least 10:1. Still, in another non-limiting embodiment, the tertiary aspect ratio length:height of the body 101 can be not greater than 100:1, such as not greater than 50:1, not greater than 10:1, not greater than 8:1, not greater than 6:1, not greater than 5:1, not greater than 4:1, not greater than 3:1. It will be appreciated that the tertiary aspect ratio the body 101 can be within a range including any of the minimum and maximum ratios and above.

The abrasive particles of the embodiments herein, including the shaped abrasive particles can include a crystalline material, and more particularly, a polycrystalline material. Notably, the polycrystalline material can include abrasive grains. In one embodiment, the body of the abrasive particle, including for example, the body of a shaped abrasive particle can be essentially free of an organic material, such as, a binder. In at least one embodiment, the abrasive particles can consist essentially of a polycrystalline material. In another embodiment, the abrasive particles, such as shaped abrasive particles can be free of silane, and particularly, may not have a silane coating.

The abrasive particles may be made of certain material, including but not limited to nitrides, oxides, carbides, borides, oxynitrides, oxyborides, diamond, carbon-containing materials, and a combination thereof. In particular instances, the abrasive particles can include an oxide compound or complex, such as aluminum oxide, zirconium oxide, titanium oxide, yttrium oxide, chromium oxide, strontium oxide, silicon oxide, magnesium oxide, rare-earth oxides, and a combination thereof. The abrasive particles may be superabrasive particles.

In one particular embodiment, the abrasive particles can include a majority content of alumina. For at least one embodiment, the abrasive particle can include at least 80 wt % alumina, such as at least 90 wt % alumina, at least 91 wt % alumina, at least 92 wt % alumina, at least 93 wt % alumina, at least 94 wt % alumina, at least 95 wt % alumina, at least 96 wt % alumina, or even at least 97 wt % alumina. Still, in at least one particular embodiment, the abrasive particle can include not greater than 99.5 wt % alumina, such as not greater than 99 wt % alumina, not greater than 98.5 wt % alumina, not greater than 97.5 wt % alumina, not greater than 97 wt % alumina not greater than 96 wt % alumina, or even not greater than 94 wt % alumina. It will be appreciated that the abrasive particles of the embodiments herein can include a content of alumina within a range including any of the minimum and maximum percentages noted above. Moreover, in particular instances, the shaped abrasive particles can be formed from a seeded sol-gel. In at least one embodiment, the abrasive particles can consist essentially of alumina and certain dopant materials as described herein.

The abrasive particles of the embodiments herein can include particularly dense bodies, which may be suitable for use as abrasives. For example, the abrasive particles may have a body having a density of at least 95% theoretical density, such as at least 96% theoretical density, at least 97% theoretical density, at least 98% theoretical density or even at least 99% theoretical density.

The abrasive grains (i.e., crystallites) contained within the body of the abrasive particles may have an average grain size (i.e., average crystal size) that is generally not greater than about 100 microns. In other embodiments, the average grain size can be less, such as not greater than about 80 microns or not greater than about 50 microns or not greater than about 30 microns or not greater than about 20 microns or not greater than about 10 microns or not greater than 6 microns or not greater than 5 microns or not greater than 4 microns or not greater than 3.5 microns or not greater than 3 microns or not greater than 2.5 microns or not greater than 2 microns or not greater than 1.5 microns or not greater than 1 micron or not greater than 0.8 microns or not greater than 0.6 microns or not greater than 0.5 microns or not greater than 0.4 microns or not greater than 0.3 microns or even not greater than 0.2 microns. Still, the average grain size of the abrasive grains contained within the body of the abrasive particle can be at least about 0.01 microns, such as at least about 0.05 microns or at least about 0.06 microns or at least about 0.07 microns or at least about 0.08 microns or at least about 0.09 microns or at least about 0.1 microns or at least about 0.12 microns or at least about 0.15 microns or at least about 0.17 microns or at least about 0.2 microns or even at least about 0.3 microns. It will be appreciated that the abrasive particles can have an average grain size (i.e., average crystal size) within a range between any of the minimum and maximum values noted above.

The average grain size (i.e., average crystal size) can be measured based on the uncorrected intercept method using scanning electron microscope (SEM) photomicrographs. Samples of abrasive grains are prepared by making a bakelite mount in epoxy resin then polished with diamond polishing slurry using a Struers Tegramin 30 polishing unit. After polishing the epoxy is heated on a hot plate, the polished surface is then thermally etched for 5 minutes at 150° C. below sintering temperature. Individual grains (5-10 grits) are mounted on the SEM mount then gold coated for SEM preparation. SEM photomicrographs of three individual abrasive particles are taken at approximately 50,000× magnification, then the uncorrected crystallite size is calculated using the following steps: 1) draw diagonal lines from one corner to the opposite corner of the crystal structure view, excluding black data band at bottom of photo 2) measure the length of the diagonal lines as L1 and L2 to the nearest 0.1 centimeters; 3) count the number of grain boundaries intersected by each of the diagonal lines, (i.e., grain boundary intersections I1 and I2) and record this number for each of the diagonal lines, 4) determine a calculated bar number by measuring the length (in centimeters) of the micron bar (i.e., “bar length”) at the bottom of each photomicrograph or view screen, and divide the bar length (in microns) by the bar length (in centimeters); 5) add the total centimeters of the diagonal lines drawn on photomicrograph (L1+L2) to obtain a sum of the diagonal lengths; 6) add the numbers of grain boundary intersections for both diagonal lines (I1+I2) to obtain a sum of the grain boundary intersections; 7) divide the sum of the diagonal lengths (L1+L2) in centimeters by the sum of grain boundary intersections (I1+I2) and multiply this number by the calculated bar number. This process is completed at least three different times for three different, randomly selected samples to obtain an average crystallite size.

In accordance with certain embodiments, certain abrasive particles can be composite articles including at least two different types of grains within the body of the abrasive particle. It will be appreciated that different types of grains are grains having different compositions with regard to each other. For example, the body of the abrasive particle can be formed such that is includes at least two different types of grains, wherein the two different types of grains can be nitrides, oxides, carbides, borides, oxynitrides, oxyborides, diamond, and a combination thereof.

In accordance with an embodiment, the abrasive particles can have an average particle size, as measured by the largest dimension (i.e., length) of at least about 100 microns. In fact, the abrasive particles can have an average particle size of at least about 150 microns, such as at least about 200 microns, at least about 300 microns, at least about 400 microns, at least about 500 microns, at least about 600 microns, at least about microns, at least about 800 microns, or even at least about 900 microns. Still, the abrasive particles of the embodiments herein can have an average particle size that is not greater than about 5 mm, such as not greater than about 3 mm, not greater than about 2 mm, or even not greater than about 1.5 mm. It will be appreciated that the abrasive particles can have an average particle size within a range between any of the minimum and maximum values noted above.

FIG. 1A includes an illustration of a shaped abrasive particle having a two-dimensional shape as defined by the plane of the upper major surface 102 or major surface 103, which has a generally triangular two-dimensional shape. It will be appreciated that the shaped abrasive particles of the embodiments herein are not so limited and can include other two-dimensional shapes. For example, the shaped abrasive particles of the embodiment herein can include particles having a body with a two-dimensional shape as defined by a major surface of the body from the group of shapes including polygons, regular polygons, irregular polygons, irregular polygons including arcuate or curved sides or portions of sides, ellipsoids, numerals, Greek alphabet characters, Latin alphabet characters, Russian alphabet characters, Kanji characters, complex shapes having a combination of polygons shapes, shapes including a central region and a plurality of arms (e.g., at least three arms) extending from a central region (e.g., star shapes), and a combination thereof. Particular polygonal shapes include rectangular, trapezoidal, quadrilateral, pentagonal, hexagonal, heptagonal, octagonal, nonagonal, decagonal, and any combination thereof. In another instance, the finally-formed shaped abrasive particles can have a body having a two-dimensional shape such as an irregular quadrilateral, an irregular rectangle, an irregular trapezoid, an irregular pentagon, an irregular hexagon, an irregular heptagon, an irregular octagon, an irregular nonagon, an irregular decagon, and a combination thereof. An irregular polygonal shape is one where at least one of the sides defining the polygonal shape is different in dimension (e.g., length) with respect to another side. As illustrated in other embodiments herein, the two-dimensional shape of certain shaped abrasive particles can have a particular number of exterior points or external corners. For example, the body of the shaped abrasive particles can have a two-dimensional polygonal shape as viewed in a plane defined by a length and width, wherein the body comprises a two-dimensional shape having at least 4 exterior points (e.g., a quadrilateral), at least 5 exterior points (e.g., a pentagon), at least 6 exterior points (e.g., a hexagon), at least 7 exterior points (e.g., a heptagon), at least 8 exterior points (e.g., an octagon), at least 9 exterior points (e.g., a nonagon), and the like.

FIG. 1C includes a perspective view illustration of a shaped abrasive particle according to another embodiment. Notably, the shaped abrasive particle 170 can include a body 171 including a surface 172 and a surface 173, which may be referred to as end surfaces 172 and 173. The body can further include major surfaces 174, 175, 176, 177 extending between and coupled to the end surfaces 172 and 173. The shaped abrasive particle of FIG. 1C is an elongated shaped abrasive particle having a longitudinal axis 180 that extends along the major surface 175 and through the midpoint 184 between the end surfaces 172 and 173. For particles having an identifiable two-dimensional shape, such as the shaped abrasive particles of FIGS. 1A-C, the longitudinal axis is the dimension that would be readily understood to define the length of the body through the midpoint on a major surface. For example, in FIG. 1C, the longitudinal axis 180 of the shaped abrasive particle 170 extends between the end surfaces 172 and 173 parallel to the edges defining the major surface as shown. Such a longitudinal axis is consistent with how one would define the length of a rod. Notably, the longitudinal axis 180 does not extend diagonally between the corners joining the end surfaces 172 and 173 and the edges defining the major surface 175, even though such a line may define the dimension of greatest length. To the extent that a major surface has undulations or minor imperfections from a perfectly planar surface, the longitudinal axis can be determined using a top-down, two-dimensional image that ignores the undulations.

It will be appreciated that the surface 175 is selected for illustrating the longitudinal axis 180, because the body 171 has a generally square cross-sectional contour as defined by the end surfaces 172 and 173. As such, the surfaces 174, 175, 176, and 177 can be approximately the same size relative to each other. However, in the context of other elongated abrasive particles, the surfaces 172 and 173 can have a different shape, for example, a rectangular shape, and as such, at least one of the surfaces 174, 175, 176, and 177 may be larger relative to the others. In such instances, the largest surface can define the major surface and the longitudinal axis would extend along the largest of those surfaces through the midpoint 184 and may extend parallel to the edges defining the major surface. As further illustrated, the body 171 can include a lateral axis 181 extending perpendicular to the longitudinal axis 180 within the same plane defined by the surface 175. As further illustrated, the body 171 can further include a vertical axis 182 defining a height of the abrasive particle, were in the vertical axis 182 extends in a direction perpendicular to the plane defined by the longitudinal axis 180 and lateral axis 181 of the surface 175.

It will be appreciated that like the thin shaped abrasive particle of FIGS. 1A-B, the elongated shaped abrasive particle of FIG. 1C can have various two-dimensional shapes, such as those defined with respect to the shaped abrasive particle of FIGS. 1A-B. The two-dimensional shape of the body 171 can be defined by the shape of the perimeter of the end surfaces 172 and 173. The elongated shaped abrasive particle 170 can have any of the attributes of the shaped abrasive particles of the embodiments herein.

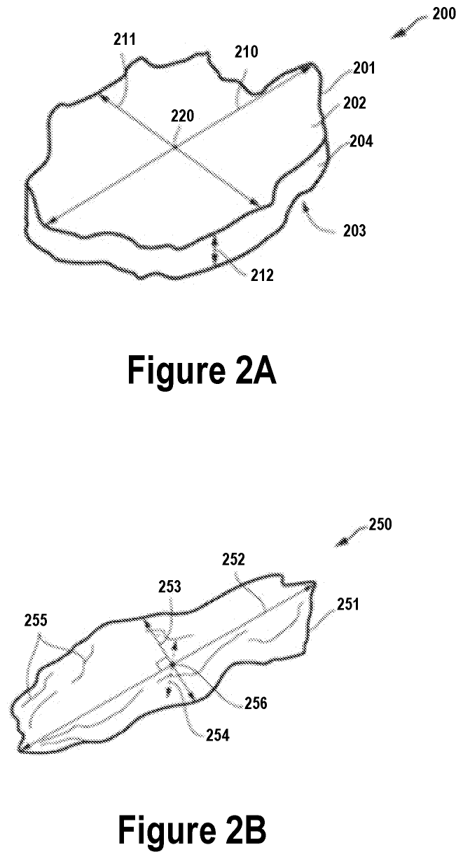

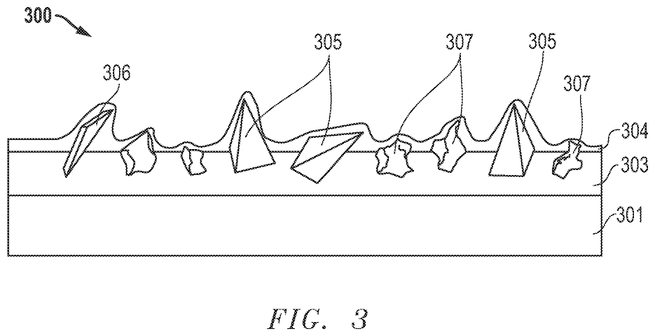

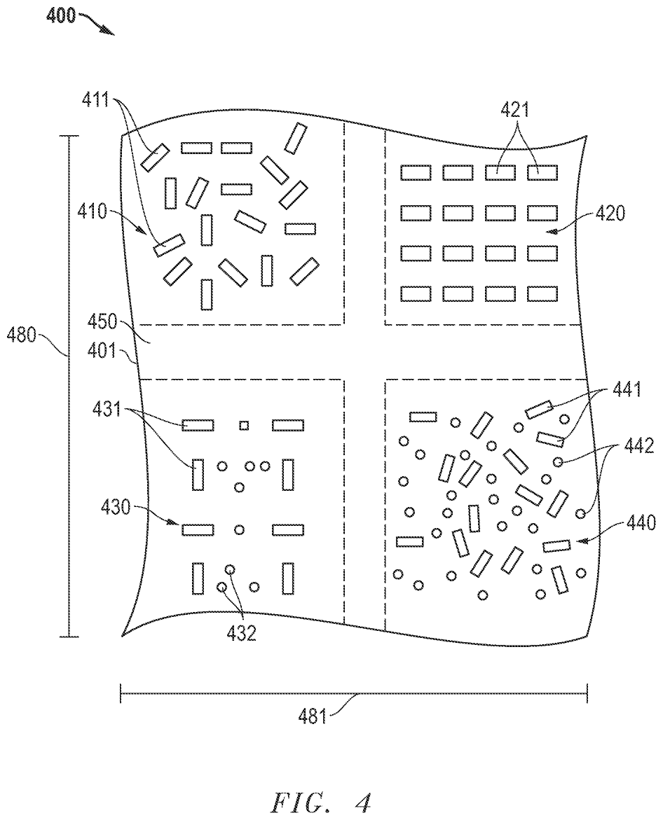

FIG. 2A includes a perspective view illustration of a controlled height abrasive particle according (CHAP) to an embodiment. As illustrated, the CHAP 200 can include a body 201 including a first major surface 202, a second major surface 203, and a side surface 204 extending between the first and second major surfaces 202 and 203. As illustrated in FIG. 2A, the body 201 can have a thin, relatively planar shape, wherein the first and second major surfaces 202 and 203 are larger than the side surface 204 and substantially parallel to each other. Moreover, the body 201 can include a longitudinal axis 210 extending through the midpoint 220 and defining a length of the body 201. The body 201 can further include a lateral axis 211 on the first major surface 202, which extends through the midpoint 220 of the first major surface 202, perpendicular to the longitudinal axis 210, and defining a width of the body 201.

The body 201 can further include a vertical axis 212, which can define a height (or thickness) of the body 201. As illustrated, the vertical axis 212 can extend along the side surface 204 between the first and second major surfaces 202 and 203 in a direction generally perpendicular to the plane defined by the axes 210 and 211 on the first major surface. For thin-shaped bodies, such as the CHAP 200 illustrated in FIG. 2A, the length can be equal to or greater than the width and the length can be greater than the height. It will be appreciated that reference herein to length, width, and height of the abrasive particles may be referenced to average values taken from a suitable sampling size of abrasive particles of a batch of abrasive particles.

Unlike the shaped abrasive particles of FIGS. 1A, 1B, and 1C, the CHAP 200 of FIG. 2A does not have a readily identifiable two-dimensional shape based on the perimeter of the first or second major surfaces 202 and 203. Such abrasive particles may be formed in a variety of ways, including but not limited to, fracturing of a thin layer of material to form abrasive particles having a controlled height but with irregularly formed, planar, major surfaces. For such particles, the longitudinal axis is defined as the longest dimension on the major surface that extends through a midpoint on the surface. To the extent that the major surface has undulations, the longitudinal axis can be determined using a top-down, two-dimensional image that ignores the undulations. Moreover, as noted above in FIG. 1B, a closest-fit circle may be used to identify the midpoint of the major surface and identification of the longitudinal and lateral axes.

FIG. 2B includes an illustration of a non-shaped particle, which may be an elongated, non-shaped abrasive particle or a secondary particle, such as a diluent grain, a filler, an agglomerate, or the like. Shaped abrasive particles may be formed through particular processes, including molding, printing, casting, extrusion, and the like. Shaped abrasive particles can be formed such that the each particle has substantially the same arrangement of surfaces and edges relative to each other. For example, a group of shaped abrasive particles generally have the same arrangement and orientation and or two-dimensional shape of the surfaces and edges relative to each other. As such, the shaped abrasive particles have a relatively high shape fidelity and consistency in the arrangement of the surfaces and edges relative to each other. Moreover, constant height abrasive particles (CHAPs) can also be formed through particular processes that facilitate formation of thin-shaped bodies that can have irregular two-dimensional shapes when viewing the major surface top-down. CHAPs can have less shape fidelity than shaped abrasive particles, but can have substantially planar and parallel major surfaces separated by a side surface.

By contrast, non-shaped particles can be formed through different processes and have different shape attributes compared to shaped abrasive particles and CHAPs. For example, non-shaped particles are typically formed by a comminution process wherein a mass of material is formed and then crushed and sieved to obtain abrasive particles of a certain size. However, a non-shaped particle will have a generally random arrangement of surfaces and edges, and generally will lack any recognizable two-dimensional or three dimensional shape in the arrangement of the surfaces and edges. Moreover, non-shaped particles do not necessarily have a consistent shape with respect to each other, and therefore have a significantly lower shape fidelity compared to shaped abrasive particles or CHAPs. The non-shaped particles generally are defined by a random arrangement of surfaces and edges for each particle and with respect to other non-shaped particles

FIG. 2B includes a perspective view illustration of a non-shaped particle. The non-shaped particle 250 can have a body 251 including a generally random arrangement of edges 255 extending along the exterior surface of the body 251. The body can further include a longitudinal axis 252 defining the longest dimension of the particle. The longitudinal axis 252 defines the longest dimension of the body as viewed in two-dimensions. Thus, unlike shaped abrasive particles and CHAPs, where the longitudinal axis is measured on the major surface, the longitudinal axis of a non-shaped particle is defined by the points on the body furthest from each other as the particle is viewed in two-dimensions using an image or vantage that provides a view of the particle's longest dimension. That is, an elongated particle, but non-shaped particles, such as illustrated in FIG. 2B, should be viewed in a perspective that makes the longest dimension apparent to properly evaluate the longitudinal axis. The body 251 can further include a lateral axis 253 extending perpendicular to the longitudinal axis 252 and defining a width of the particle. The lateral axis 253 can extend perpendicular to the longitudinal axis 252 through the midpoint 256 of the longitudinal axis in the same plane used to identify the longitudinal axis 252. The abrasive particle may have a height (or thickness) as defined by the vertical axis 254. The vertical axis 254 can extend through the midpoint 256 but in a direction perpendicular to the plane used to define the longitudinal axis 252 and lateral axis 253. To evaluate the height, one may have to change the perspective of view of the abrasive particle to look at the particle from a different vantage than is used to evaluate the length and width.

As will be appreciated, the abrasive particle can have a length defined by the longitudinal axis 252, a width defined by the lateral axis 253, and a vertical axis 254 defining a height. As will be appreciated, the body 251 can have a primary aspect ratio of length:width such that the length is equal to or greater than the width. Furthermore, the length of the body 251 can be equal to or greater than or equal to the height. Finally, the width of the body 251 can be greater than or equal to the height. In accordance with an embodiment, the primary aspect ratio of length:width can be at least 1.1:1, at least 1.2:1, at least 1.5:1, at least 1.8:1, at least 2:1, at least 3:1, at least 4:1, at least 5:1, at least 6:1, or even at least 10:1. In another non-limiting embodiment, the body 251 of the elongated shaped abrasive particle can have a primary aspect ratio of length:width of not greater than 100:1, not greater than 50:1, not greater than 10:1, not greater than 6:1, not greater than 5:1, not greater than 4:1, not greater than 3:1, or even not greater than 2:1. It will be appreciated that the primary aspect ratio of the body 251 can be within a range including any of the minimum and maximum ratios noted above.

Furthermore, the body 251 can include a secondary aspect ratio of width:height that can be at least 1.1:1, such as at least 1.2:1, at least 1.5:1, at least 1.8:1, at least 2:1, at least 3:1, at least 4:1, at least 5:1, at least 8:1, or even at least 10:1. Still, in another non-limiting embodiment, the secondary aspect ratio width:height of the body 251 can be not greater than 100:1, such as not greater than 50:1, not greater than 10:1, not greater than 8:1, not greater than 6:1, not greater than 5:1, not greater than 4:1, not greater than 3:1, or even not greater than 2:1. It will be appreciated the secondary aspect ratio of width:height can be with a range including any of the minimum and maximum ratios of above.

In another embodiment, the body 251 can have a tertiary aspect ratio of length:height that can be at least 1.1:1, such as at least 1.2:1, at least 1.5:1, at least 1.8:1, at least 2:1, at least 3:1, at least 4:1, at least 5:1, at least 8:1, or even at least 10:1. Still, in another non-limiting embodiment, the tertiary aspect ratio length:height of the body 251 can be not greater than 100:1, such as not greater than 50:1, not greater than 10:1, not greater than 8:1, not greater than 6:1, not greater than 5:1, not greater than 4:1, not greater than 3:1, It will be appreciated that the tertiary aspect ratio the body 251 can be with a range including any of the minimum and maximum ratios and above.

The non-shaped particle 250 can have any of the attributes of abrasive particles described in the embodiments herein, including for example but not limited to, composition, microstructural features (e.g., average grain size), hardness, porosity, and the like.

The abrasive articles of the embodiments herein may incorporate different types of particles, including different types of abrasive particles, different types of secondary particles, or any combination thereof. For example, in one embodiment, the coated abrasive article can include a first type of abrasive particle comprising shaped abrasive particles and a second type of abrasive particle. The second type of abrasive particle may be a shaped abrasive particle or a non-shaped abrasive particle.

FIG. 3 includes a cross-sectional illustration of a coated abrasive article incorporating particulate material in accordance with an embodiment. As illustrated, the coated abrasive 300 can include a substrate 301 and a make coat 303 overlying a surface of the substrate 301. The coated abrasive 300 can further include a first type of particulate material 305 in the form of a first type of shaped abrasive particle, a second type of particulate material 306 in the form of a second type of shaped abrasive particle, and a third type of particulate material 307, which may be a secondary particle, such as a diluent abrasive particle, a non-shaped abrasive particle, a filler, and the like. The coated abrasive 300 may further include size coat 304 overlying and bonded to the abrasive particulate materials 305, 306, 307, and the size coat 304. It will be appreciated that other layers or materials may be added to the substrate other component layers, including for example, but not limited to, a frontfill, a backfill, and the like as known to those of ordinary skill in the art.

According to one embodiment, the substrate 301 can include an organic material, inorganic material, and a combination thereof. In certain instances, the substrate 301 can include a woven material. However, the substrate 301 may be made of a non-woven material. Particularly suitable substrate materials can include organic materials, including polymers, and particularly, polyester, polyurethane, polypropylene, polyimides such as KAPTON from DuPont, paper or any combination thereof. Some suitable inorganic materials can include metals, metal alloys, and particularly, foils of copper, aluminum, steel, and a combination thereof. In the context of a non-woven substrate, which may be open web of fibers, the abrasive particles may be adhered to the fibers by one or more adhesive layers. In such non-woven products, the abrasive particles are coating the fibers, but not necessarily forming a conformal layer overlying a major surface of the substrate as illustrated in FIG. 3. It will be appreciated that such non-woven products are included in the embodiments herein.

The make coat 303 can be applied to the surface of the substrate 301 in a single process, or alternatively, the particulate materials 305, 306, 307 can be combined with a make coat 303 material and the combination of the make coat 303 and particulate materials 305-307 can be applied as a mixture to the surface of the substrate 301. In certain instances, controlled deposition or placement of the particles 305-307 in the make coat may be better suited by separating the processes of applying the make coat 303 from the deposition of the abrasive particulate materials 305-307 in the make coat 303. Still, it is contemplated that such processes may be combined. Suitable materials of the make coat 303 can include organic materials, particularly polymeric materials, including for example, polyesters, epoxy resins, polyurethanes, polyamides, polyacrylates, polymethacrylates, polyvinylchlorides, polyethylene, polysiloxane, silicones, cellulose acetates, nitrocellulose, natural rubber, starch, shellac, and mixtures thereof. In one embodiment, the make coat 303 can include a polyester resin. The coated substrate can then be heated in order to cure the resin and the abrasive particulate material to the substrate. In general, the coated substrate 301 can be heated to a temperature of between about 100° C. to less than about 250° C. during this curing process.

The particulate materials 305-307 can include different types of abrasive particles according to embodiments herein. The different types of abrasive particles can include different types of shaped abrasive particles, different types of secondary particles or a combination thereof. The different types of particles can be different from each other in composition, two-dimensional shape, three-dimensional shape, grain size, particle size, hardness, friability, agglomeration, and a combination thereof. As illustrated, the coated abrasive 300 can include a first type of shaped abrasive particle 305 having a generally pyramidal shape and a second type of shaped abrasive particle 306 having a generally triangular two-dimensional shape. The coated abrasive 300 can include different amounts of the first type and second type of shaped abrasive particles 305 and 306. It will be appreciated that the coated abrasive may not necessarily include different types of shaped abrasive particles, and can consist essentially of a single type of shaped abrasive particle. As will be appreciated, the shaped abrasive particles of the embodiments herein can be incorporated into various fixed abrasives (e.g., bonded abrasives, coated abrasive, non-woven abrasives, thin wheels, cut-off wheels, reinforced abrasive articles, and the like), including in the form of blends, which may include different types of shaped abrasive particles, secondary particles, and the like.

The particles 307 can be secondary particles different than the first and second types of shaped abrasive particles 305 and 306. For example, the secondary particles 307 can include crushed abrasive grit representing non-shaped abrasive particles.

After sufficiently forming the make coat 303 with the abrasive particulate materials 305-307 contained therein, the size coat 304 can be formed to overlie and bond the abrasive particulate material 305 in place. The size coat 304 can include an organic material, may be made essentially of a polymeric material, and notably, can use polyesters, epoxy resins, polyurethanes, polyamides, polyacrylates, polymethacrylates, poly vinyl chlorides, polyethylene, polysiloxane, silicones, cellulose acetates, nitrocellulose, natural rubber, starch, shellac, and mixtures thereof.

### III. Example Abrasive Articles

FIG. 4 includes a top view of a portion of a coated abrasive according to an embodiment. The coated abrasive article 400 can include a plurality of regions, such as a first region 410, a second region 420, a third region 430 and a fourth region 440. Each of the regions 410, 420, 430, and 440 can be separated by a channel region 450, wherein the channel region 450 defines a region the backing that is free of particles. The channel region 450 can have any size and shape and may be particularly useful for removing swarf and improved grinding operations. The channel region may have a length (i.e., longest dimension) and width (i.e., shortest dimension perpendicular to the length) that is greater than the average spacing between immediately adjacent abrasive particles within any of the regions 410, 420, 430, and 440. The channel region 450 is an optional feature for any of the embodiments herein.

As further illustrated, the first region 410 can include a group of shaped abrasive particles 411 having a generally random rotational orientation with respect to each other. The group of shaped abrasive particles 411 can be arranged in a random distribution relative to each other, such that there is no discernable short-range or long-range order with regard to the placement of the shaped abrasive particles 411. Notably, the group of shaped abrasive particles 411 can be substantially homogenously distributed within the first region 410, such that the formation of clumps (two or more particles in contact with each other) is limited. It will be appreciated that the grain weight of the group of shaped abrasive particles 411 in the first region 410 can be controlled based on the intended application of the coated abrasive.

The second region 420 can include a group of shaped abrasive particles 421 arranged in a controlled distribution relative to each other. Moreover, the group of shaped abrasive particles 421 can have a regular and controlled rotational orientation relative to each other. As illustrated, the group of shaped abrasive particles 421 can have generally the same rotational orientation as defined by the same rotational angle on the backing of the coated abrasive 401. Notably, the group of shaped abrasive particles 421 can be substantially homogenously distributed within the second region 420, such that the formation of clumps (two or more particles in contact with each other) is limited. It will be appreciated that the grain weight of the group of shaped abrasive particles 421 in the second region 420 can be controlled based on the intended application of the coated abrasive.

The third region 430 can include a plurality of groups of shaped abrasive particles 421 and secondary particles 432. The group of shaped abrasive particles 431 and secondary particles 432 can be arranged in a controlled distribution relative to each other. Moreover, the group of shaped abrasive particles 431 can have a regular and controlled rotational orientation relative to each other. As illustrated, the group of shaped abrasive particles 431 can have generally one of two types of rotational orientations on the backing of the coated abrasive 401. Notably, the group of shaped abrasive particles 431 and secondary particles 432 can be substantially homogenously distributed within the third region 430, such that the formation of clumps (two or more particles in contact with each other) is limited. It will be appreciated that the grain weight of the group of shaped abrasive particles 431 and secondary particles 432 in the third region 430 can be controlled based on the intended application of the coated abrasive.

The fourth region 440 can include a group of shaped abrasive particles 441 and secondary particles 442 having a generally random distribution with respect to each other. Additionally, the group of shaped abrasive particles 441 can have a random rotational orientation with respect to each other. The group of shaped abrasive particles 441 and secondary particles 442 can be arranged in a random distribution relative to each other, such that there is no discernable short-range or long-range order. Notably, the group of shaped abrasive particles 441 and the secondary particles 442 can be substantially homogenously distributed within the fourth region 440, such that the formation of clumps (two or more particles in contact with each other) is limited. It will be appreciated that the grain weight of the group of shaped abrasive particles 441 and secondary particles 442 in the fourth region 440 can be controlled based on the intended application of the coated abrasive.

As illustrated in FIG. 4, the coated abrasive article 400 can include different regions 410, 420, 430, and 440, each of which can include different groups of particles, such as shaped particles and secondary particles. The coated abrasive article 400 is intended to illustrate the different types of groupings, arrangements and distributions of particles that may be created using the systems and processes of the embodiments herein. The illustration is not intended to be limited to only those groupings of particles and it will be appreciated that coated abrasive articles can be made including only one region as illustrated in FIG. 4. It will also be understood that other coated abrasive articles can be made including a different combination or arrangement of one or more of the regions illustrated in FIG. 4.

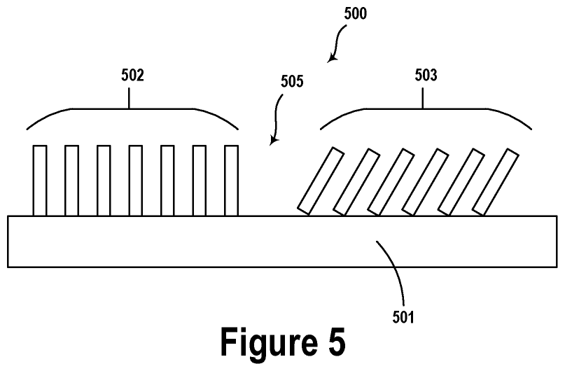

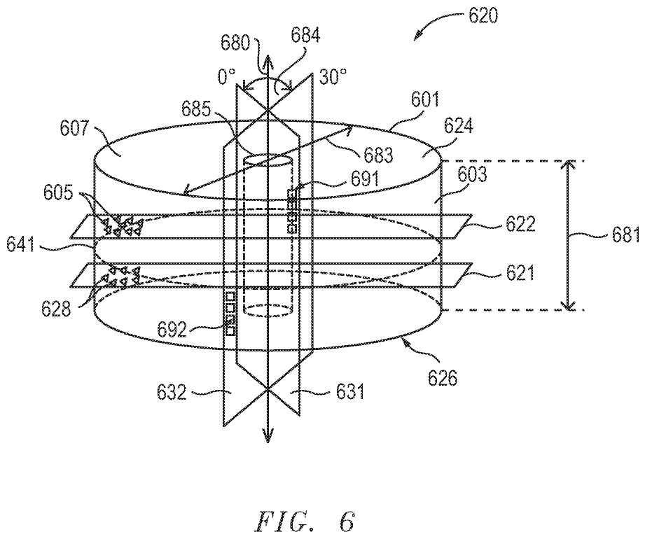

According to another embodiment, a coated abrasive article may be formed that includes different groups of abrasive particles, wherein the different groups have different tilt angles with respect to each other. For example, as illustrated in FIG. 5, a cross-sectional illustration of a portion of a coated abrasive is provided. The coated abrasive 500 can include a backing 501 and a first group of abrasive particles 502, wherein each of the abrasive particles in the first group of abrasive particles 502 have a first average tilt angle. The coated abrasive 500 can further include a second group of abrasive particles 503, wherein each of the abrasive particles in the second group of abrasive particles 503 have a second average tilt angle. According to one embodiment the first group of abrasive particles 502 and the second group of abrasive particles 503 can be separated by a channel region 505. Moreover, the first average tilt angle can be different than the second average tilt angle. In a more particular embodiment, the first group of abrasive particles may be oriented in an upright orientation and the second group of abrasive particles may be oriented in a slanted orientation. Without wishing to be tied to a particular theory, it is thought that controlled variation of the tilt angle for different groups of abrasive particles in different regions of the coated abrasive may facilitate improved performance of the coated abrasive.

According to one particular aspect, the content of abrasive particles overlying the backing can be controlled based on the intended application. For example, the abrasive particles can be overlying at least 5% of the total surface area of the backing, such as at least 10% or at least 20% or at least 30% or at least 40% or at least 50% or at least 60% or at least 70% or at least 80% or at least 90%. In still another embodiment, the coated abrasive article may be essentially free of silane.

Furthermore, the abrasive articles of the embodiments herein can have a particular content of particles overlying the substrate. Moreover, it is noted that for certain contents of particles on the backing, such as open coat densities, the industry has found it challenging to obtain certain contents of particles in desired vertical orientations. In one embodiment, the particles can define an open coat abrasive product having a coating density of particles (i.e., abrasive particles, secondary particles, or both abrasive particles and secondary particles) of not greater than about 70 particles/cm². In other instances, the density of shaped abrasive particle per square centimeter of the abrasive article may be not greater than about 65 particles/cm², such as not greater than about 60 particles/cm², not greater than about 55 particles/cm², or even not greater than about 50 particles/cm². Still, in one non-limiting embodiment, the density of the open coat coated abrasive using the shaped abrasive particle herein can be at least about 5 particles/cm², or even at least about 10 particles/cm². It will be appreciated that the density of shaped abrasive particles per square centimeter of abrasive article can be within a range between any of the above minimum and maximum values.

In certain instances, the abrasive article can have an open coat density of not greater than about 50% of particles (i.e., abrasive particles or secondary particles or the total of abrasive particles and secondary particles) covering the exterior abrasive surface of the article. In other embodiments, the area of the abrasive particles relative to the total area of the surface on which the particles are placed can be not greater than about 40%, such as not greater than about 30%, not greater than about 25%, or even not greater than about 20%. Still, in one non-limiting embodiment, the percentage coating of the particles relative to the total area of the surface can be at least about 5%, such as at least about 10%, at least about 15%, at least about 20%, at least about 25%, at least about 30%, at least about 35%, or even at least about 40%. It will be appreciated that the percent coverage of the particles for the total area of abrasive surface can be within a range between any of the above minimum and maximum values.

Some abrasive articles may have a particular content of particles (i.e., abrasive particles or secondary particles or the total of abrasive particles and secondary particles) for a given area (e.g., ream, wherein 1 ream=30.66 m²) of the backing. For example, in one embodiment, the abrasive article may utilize a normalized weight of particles of at least about 1 lbs/ream (14.8 grams/m²), such as at least 5 lbs/ream or at least 10 lbs/ream or at least about 15 lbs/ream or at least about 20 lbs/ream or at least about 25 lbs/ream or even at least about 30 lbs/ream. Still, in one non-limiting embodiment, the abrasive article can include a normalized weight of particles of not greater than about 90 lbs/ream (1333.8 grams/m²), such as not greater than 80 lbs/ream or not greater than 70 lbs/ream or not greater than 60 lbs/ream or not greater than about 50 lbs/ream or even not greater than about 45 lbs/ream. It will be appreciated that the abrasive articles of the embodiments herein can utilize a normalized weight of particles within a range between any of the above minimum and maximum values.

In certain instances, the abrasive articles can be used on particular workpieces. A suitable exemplary workpiece can include an inorganic material, an organic material, a natural material, and a combination thereof. According to a particular embodiment, the workpiece can include a metal or metal alloy, such as an iron-based material, a nickel-based material, and the like. In one embodiment, the workpiece can be steel, and more particularly, can consist essentially of stainless steel (e.g., 304 stainless steel).

In another embodiment, the fixed abrasive article may be a bonded abrasive, including abrasive particles contained within the three-dimensional volume of the bond material, which can be distinct from certain other fixed abrasive articles including, for example, coated abrasive articles, which generally include a single layer of abrasive particles contained within a binder, such as a make coat and/or size coat. Furthermore, coated abrasive articles generally include a backing as a support for the layer of abrasive particles and binder. By contrast, bonded abrasive articles are generally self-supporting articles including a three-dimensional volume of abrasive particles, bond material, and optionally some porosity. Bonded abrasive articles may not necessarily include a substrate, and can be essentially free of a substrate.

FIG. 6 includes a perspective view illustration of a bonded abrasive article in accordance with an embodiment. As illustrated, the bonded abrasive article 620 can have a body 601 of a generally cylindrical shape including an upper surface 624, a bottom surface 626, and a side surface 603 extending between the upper surface 624 and bottom surface 626. It will be appreciated that the fixed abrasive article of FIG. 6 is a non-limiting example, and other shapes of the body may be utilized including, but not limited to, conical, cup-shaped, depressed center wheels (e.g., T42), and the like. Finally, as further illustrated, the body 601 can include a central opening 685 which may be configured to accept an arbor or shaft for mounting of the body 601 on a machine configured to rotate the body 601 and facilitate a material removal operation.

The bonded abrasive article 620 can have a body 601 including abrasive particles, including for example, the groups of abrasive particles 605 and 628, contained within the volume of the body 601. The abrasive particles may be contained within the three-dimensional volume of the body 601 by a bond material 607 that can extend throughout the three-dimensional volume of the body 601. In accordance with an embodiment, the bond material 607 can include materials such as vitreous, polycrystalline, monocrystalline, organic (e.g., resin), metal, metal alloys, and a combination thereof.

In a particular embodiment, the abrasive particles may be encapsulated within the bond material 607. As used herein, “encapsulated” refers to a condition whereby at least one of the abrasive particles is fully surrounded by a homogenous, or generally homogenous, composition of bond material. In an embodiment, the bonded abrasive article 620 can be essentially free of a fixation layer. In a particular instance, the bonded abrasive article 620 can be substantially uniform throughout a volume of the body 601. In more particular instances, the body 601 can have a substantially homogenous composition throughout the volume of the body 601.

In accordance with an embodiment, the abrasive particles contained within the bonded abrasive article 620 can include abrasive materials in accordance with those described in embodiments herein.

The bonded abrasive article 620 can include a combination of abrasive particles, including one or more types of abrasive particles, such as primary and secondary types of abrasive particles. Primary and secondary types may refer to the content of the abrasive particles within the body of the fixed abrasive article, wherein the primary type abrasive particles are present in a higher content than the secondary type of abrasive particles. In other instances, the distinction between primary and secondary types of abrasive particles may be based upon the position of the abrasive particle within the body, wherein the primary abrasive particles may be positioned to conduct an initial stage of material removal or conduct the majority of material removal compared to the secondary abrasive particles. In still other instances, the distinction between primary and secondary abrasive particles may pertain to the abrasive nature (e.g., hardness, friability, fracture mechanics, etc.) of the abrasive particles, wherein the abrasive nature of the primary particles is typically more robust as compared to the secondary type of abrasive particles. Some suitable examples of abrasive particles that may be considered as a secondary type of abrasive particle include diluent particles, agglomerated particles, unagglomerated particles, naturally occurring materials (e.g., minerals), synthetic materials, and a combination thereof.

In certain instances, the bonded abrasive article 620 can include a particular content of abrasive particles within the body 601 that may facilitate suitable material removal operations. For example, the body 601 can include a content of abrasive particles of at least 0.5 vol % and not greater than 60 vol % for a total volume of the body.

Furthermore, the body 601 of the bonded abrasive article 620 can include a particular content of bond material 607 that may facilitate suitable operation of the bonded abrasive article 620. For example, the body 601 can include a content of bond material 607 of at least 0.5 vol % and not greater than about 90 vol % for a total volume of the body.

In certain instances, the fixed abrasive article can have a body 601 including a content of porosity. The porosity can extend throughout at least a portion of the entire volume of the body 601, and in certain instances, may extend substantially uniformly throughout the entire volume of the body 601. For example, the porosity can include closed porosity or open porosity. Closed porosity can be in the form of discrete pores that are isolated from each other by bond material and/or abrasive particles. Such closed porosity may be formed by pore formers. In other instances, the porosity may be open porosity defining an interconnected network of channels extending throughout at least a portion of the three-dimensional volume of the body 601. It will be appreciated that the body 601 may include a combination of closed porosity and open porosity.

In accordance with an embodiment, the fixed abrasive article can have a body 601 including a particular content of porosity that can facilitate suitable material removal operations. For example, the body 601 can have a porosity of at least 0.5 vol % and not greater than 80 vol % for a total volume of the body.

In accordance with another embodiment, it will be appreciated that the bonded abrasive article 620 can include a body 601 including certain additives that may facilitate certain grinding operations. For example, the body 601 can include additives such as fillers, grinding aids, pore inducers, hollow materials, catalysts, coupling agents, curants, antistatic agents, suspending agents, anti-loading agents, lubricants, wetting agents, dyes, fillers, viscosity modifiers, dispersants, defoamers, and a combination thereof.

As further illustrated in FIG. 6, the body 601 can have a diameter 683, which may be varied according to the desired material removal operation. The diameter can refer to the maximum diameter of the body, particularly in those cases where the body 601 has a conical or cup-shaped contour.

Moreover, the body 601 can have a particular thickness 681 extending along the side surface 603 between the upper surface 624 and the bottom surface 626 along the axial axis 680. The body 601 can have a thickness 681, which may be an average thickness of the body 601, which can be not greater than 1 m.

In accordance with an embodiment, the body 601 may have a particular relationship between the diameter 683 and thickness 681, defining a ratio of diameter:thickness that may be suitable for certain material removal operations. For example, the body 601 can have a ratio of diameter:thickness of at least 10:1, such as at least 15:1, at least 20:1, at least 50:1, or even at least 100:1. It will be appreciated that the body may have a ratio of diameter:thickness of not greater than 10,000:1 or not greater than 1000:1.

The bonded abrasive article 620 may include at least one reinforcing material 641. In particular instances, the reinforcing material 641 can extend for a majority of the entire width (e.g., the diameter 683) of the body 601. However, in other instances, the reinforcing material 641 may extend for only a fraction of the entire width (e.g., diameter 183) of the body 601. In certain instances, the reinforcing material 641 may be included to add suitable stability to the body for certain material removal operations. In accordance with an embodiment, the reinforcing material 641 can include a material such as a woven material, a nonwoven material, a composite material, a laminated material, a monolithic material, a natural material, a synthetic material, and a combination thereof. More particularly, in certain instances, the reinforcing material 641 can include a material such as a monocrystalline material, a polycrystalline material, a vitreous material, an amorphous material, a glass (e.g., a glass fiber), a ceramic, a metal, an organic material, an inorganic material, and a combination thereof. In some instances, the reinforcing material 641 may include fiberglass, and may be formed essentially from fiberglass.

In particular instances, the reinforcing material 641 can be substantially contained within the three-dimensional volume of the body 601, more particularly, within the three-dimensional volume of the bond material 607. In certain instances, the reinforcing material 641 may intersect an exterior surface of the body 601 including, but not limited to, the upper surface 624, side surface 603, and/or bottom surface 626. For example, the reinforcing material 641 can intersect the upper surface 624 or bottom surface 626. In at least one embodiment, the reinforcing material 641 may define the upper surface 624 or bottom surface 626 of the body 601, such that the bond material 607 is disposed between one or more reinforcing materials. It will be appreciated that while a single reinforcing material 641 is illustrated in the embodiment of FIG. 6a plurality of reinforcing members may be provided within the body 601 in a variety of arrangements and orientations suitable for the intended material removal application.

As further illustrated, the body 601 can include certain axes and planes defining the three-dimensional volume of the body 601. For example, the body 601 of the fixed abrasive article 620 can include an axial axis 680. As further illustrated along the axial axis 680, the body 601 can include a first axial plane 631 extending along the axial axis 680 and through a particular diameter of the body 601 at a particular angular orientation, designated herein as 0°. The body 601 can further include a second axial plane 632 distinct from the first axial plane 631. The second axial plane 632 can extend along the axial axis 680 and through a diameter of the body 601 at an angular position, as designated by example herein as 30°. The first and second axial planes 631 and 632 of the body 601 may define particular axial collections of abrasive particles within the body 601 including, for example, the axial collection of abrasive particles 691 within the axial plane 631 and the axial collection of abrasive particles 692 within the axial plane 632. Furthermore, the axial planes of the body 601 may define sectors there between, including for example, sector 684 defined as the region between the axial planes 631 and 632 within the body 601. The sectors can include a particular group of abrasive particles that may facilitate improved material removal operations. Reference herein to features of portions of abrasive particles within the body, including for example, abrasive particles within axial planes will also be relevant to groups of abrasive particles contained within one or more sectors of the body.

As further illustrated, the body 601 can include a first radial plane 621 extending along a plane that is substantially parallel to the upper surface 624 and/or bottom surface 626 at a particular axial location along the axial axis 680. The body can further include a second radial plane 622, which can extend in a substantially parallel manner to the upper surface 624 and/or bottom surface 626 at a particular axial location along the axial axis 680. The first radial plane 621 and second radial plane 622 can be separated from each other within the body 601, and more particularly, the first radial plane 621 and second radial plane 622 can be axially separated from each other. As further illustrated, in certain instances, one or more reinforcing materials 641 may be disposed between the first and second radial planes 621 and 622. The first and second radial planes 621 and 622 may include one or more particular groups of abrasive particles including, for example, the group of abrasive particles 628 of the first radial plane 621 and the group of abrasive particles 605 of the second radial plane 622, which may have certain features relative to each other that may facilitate improved grinding performance.

The abrasive particles of the embodiments herein can include particular types of abrasive particles. For example, the abrasive particles may include shaped abrasive particles and/or elongated abrasive particles, wherein the elongated abrasive particles may have an aspect ratio of length:width or length:height of at least 1.1:1. Various methods may be utilized to obtain shaped abrasive particles. The particles may be obtained from a commercial source or fabricated. Some suitable processes used to fabricate the shaped abrasive particles can include, but is not limited to, depositing, printing (e.g., screen-printing), molding, pressing, casting, sectioning, cutting, dicing, punching, pressing, drying, curing, coating, extruding, rolling, and a combination thereof. Similar processes may be utilized to obtain elongated abrasive particles. Elongated un-shaped abrasive particles may be formed through crushing and sieving techniques.

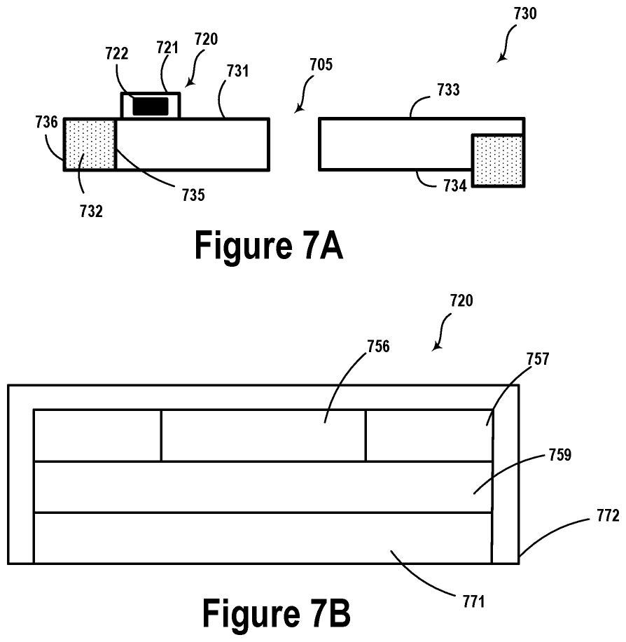

FIG. 7A illustrates a cross-sectional view of an abrasive article 730, according to an example embodiment. The abrasive article 730 includes an abrasive portion 732 and a non-abrasive portion 731, and an electronic assembly 720 coupled to the non-abrasive portion 731 of an abrasive article 730. The non-abrasive portion 731 can have a first surface 733, a second surface 734, and a side surface 735 extending between the first surface 733 and second surface 734. The first and second surfaces 733 and 734 may be major planar surfaces. The second surface 734 may be a major planar surface of the same size or different size relative to the first surface 733. As further illustrated, the non-abrasive portion 731 may include an opening 705, such as an arbor hole. The electronic assembly 720 can be coupled to the first surface 733. The electronic assembly 720 may include an electronic device 722 and package 721 as described in embodiments herein. In one embodiment, the electronic assembly 720 can include at least one electronic device 722 that may be contained within a package 721. The package 721 may be suitable for attaching the electronic assembly 720 to the body of the abrasive article 730, and may provide some suitable protection of the one or more electronic devices contained therein. In particular examples, the electronic device 722 can be encapsulated within the package 721.

According to one embodiment, the electronic device 722 can be configured to be written-to with information, store information, or provide information to other objects during a read operation. Such information may be relevant to the manufacturing of the abrasive article, operation of the abrasive article or conditions encountered by the electronic assembly 720. Reference herein to the electronic device will be understood to be reference to at least one electronic device, which can include one or more electronic devices. In at least one embodiment, the electronic device 722 can include at least one device selected from the group including an integrated circuit and chip, data transponder, a radio frequency based tag or sensor with or without chip, an electronic tag, electronic memory, a sensor, an analog to digital converter, a transmitter, a receiver, a transceiver, a modulator circuit, a multiplexer, an antenna, a near-field communication device, a power source, a display (e.g., LCD or OLED screen), optical devices (e.g., LEDs), global positioning system (GPS) or device, or any combination thereof. In some instances, the electronic device may optionally include a substrate, a power source, or both. In one particular embodiment, the electronic device 722 can include a tag, such as a passive radio frequency identification (RFID) tag. In another embodiment, the electronic device 722 can include an active radio frequency identification (RFID) tag. An active RFID tag can include a power supply, such as a batter or inductive capacitive (LC) tank circuit. In a further embodiment, the electronic device can be wired or wireless.

According to one aspect, the electronic device 722 can include a sensor. The sensor may be selectively operated by any system and/or individual within the supply chain. For example, the sensor can be configured to sense one or more processing conditions during the formation of the abrasive article. In another embodiment, the sensor may be configured to sense a condition during use of the abrasive article. In yet another embodiment, the sensor can be configured to sense a condition in the environment of the abrasive article. The sensor can include an acoustic sensor (e.g., ultrasound sensor), force sensor, vibration sensor, temperature sensor, moisture sensor, pressure sensor, gas sensor, timer, accelerometer, gyroscope, or any combination thereof. The sensor can be configured to alert any system and/or individual associated with the abrasive article, such as a manufacturer and/or customer to a particular condition sensed by the sensor. The sensor may be configured to generate an alarm signal to one or more systems and/or individuals in the supply chain, including but not limited to, manufacturers, distributors, customers, users, or any combination thereof.

In another embodiment, the electronic device 722 may include a near-field communication device. A near field communication device can be any device capable of transmitting information via electromagnetic radiation within a certain defined radius of the device, typically less than 20 meters. The near-field communication device can be coupled to one or more electronic devices, including for example a sensor. In one particular embodiment, a sensor can be coupled to the near-field communication device and configured to relay information to one or systems and/or individuals in the supply chain via the near-field communication device.

In an alternative embodiment, the electronic device 722 can include a transceiver. A transceiver can be a device that can receive information and/or transmit information. Unlike passive RFID tags or passive near-field communication devices, which are generally read-only devices that store information for a read operation, a transceiver can actively transmit information without having to conduct an active read operation. Moreover, the transceiver may be capable of transmitting information over various select frequencies, which may improve the communication capabilities of the electronic assembly with a variety of systems and/or individuals in the supply chain.

FIG. 7B illustrates a cross-sectional view of an electronic assembly, according to an example embodiment. In accordance with one aspect, the electronic assembly 720 may include one or more electronic devices, including for example electronic device 756 and electronic device 757. In certain instances, the electronic assembly 720 may include a substrate 759 upon which the one or more electronic devices 756 and 757 can be disposed. In yet other instances, the electronic assembly 720 may further include a first portion 771 and a second portion 772. The first portion 771 and second portion 772 may be part of a package that may overlie at least a portion of the electronic assembly 720. The package 721 may consist essentially of the first and second portions 771 and 772. For example, as illustrated in FIG. 7B, the first portion 771 can be underlying the substrate 759 and one or more electronic devices 756 and 757. In certain instances, the first portion 771 can be coupled to, such as directly contacting, the second portion 772. In still another embodiment, electronic assembly 720 may include a first portion 771 that is underlying and partially enveloping at least a portion of the substrate 1759 and the one or more electronic devices 756 and 757. The second portion 772 can be overlying at least a portion of the one or more electronic devices 756 and 757. The second portion 772 may be indirectly coupled or directly coupled (e.g., directly contacting or bonded to) the first portion 771. As illustrated, the first portion 771 and second portion 772 can substantially surround the entire one or more electronic devices 756 and 757 as well as substrate 759.

The first portion 771 can underlie at least a portion, such as at least 50% of the electronic device 757. The first portion 771 can electrically insulate and isolate the electronic device 757 from the non-abrasive portion to which it is coupled. In particular instances, the first portion 771 can be disposed between and electrically insulating at least one of the at least one or more electronic devices 756 and 757 from the body of the abrasive article. More particularly, the electronic devices 756 and/or 757 may include at least one antenna, and the first portion 771 can be disposed between and electrically insulating the antenna from the body of the abrasive article.

In certain instances, second portion 772 may act as a protective layer. In some instances, the substrate can serve as a protective layer or facilitate bonding of the electronic assembly to a body to obviate the use of a protective layer that is disposed underlying the substrate. In another instance, the protective layer may be disposed to underlie the electronic device and an upper surface and side surfaces of the electronic devices 757 or 756 may not be covered by the protective layer. In a further embodiment, the electronic assembly 720 can include an extra protection layer that is disposed over and/or under the second portion for additional protection. The second portion 772 can act as a protective layer to limit impact of coolant and swarf on the electronic assembly. In other instances, the protective layer may protect the electronic devices from mechanical damage or chemical damage during re-profiling, dressing, maintenance of the abrasive portion or non-abrasive portion, and the like.

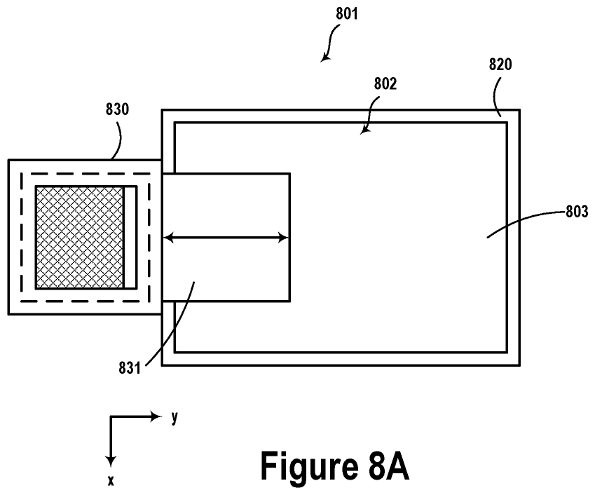

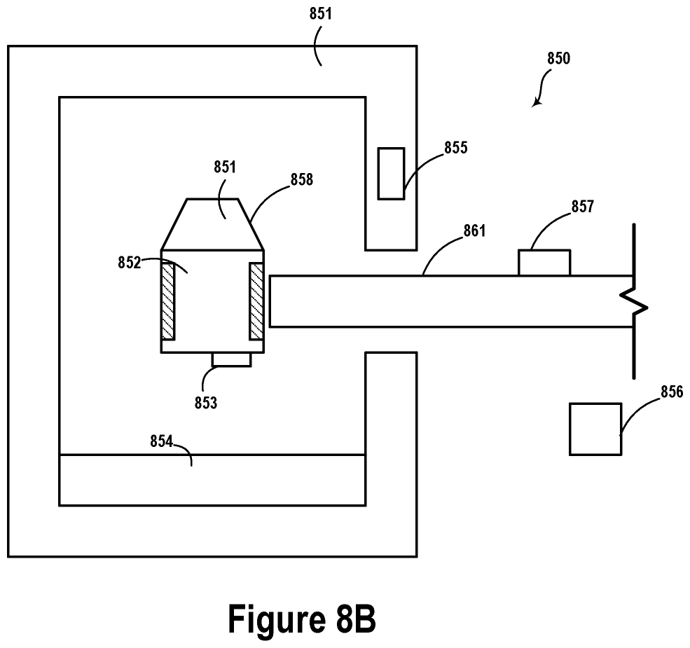

FIG. 8A illustrates a top-down view of a releasable coupling of an electronic assembly on a body, according to an example embodiment. As illustrated, the body 801 can include an upper surface 802. An electronic assembly 803 may be contained within a cavity 820 in the body 801. The electronic assembly 803 may be press-fit in the cavity 820. A securing assembly 830 including a securing element 831 may be configured to translate from and engaged position to a disengaged position. In an engaged position, as illustrated in FIG. 8A, the securing element 831 can be overlying and engaging the electronic assembly 803, thus securing the electronic assembly 803 to the body 801. In a disengaged position, the securing element 831 may be spaced apart from and disengaged from the electronic assembly 803. The securing element 831 may articulate between the engaged position and the disengaged position by translating in the Y-direction. In the disengaged position, the electronic assembly 803 is in a non-secure position and may be readily removed from the body 801. In such instances, removal of electronic assembly 803 from the body 801 may be accomplished without need for applying heat or other chemical additives to remove or dissolve an adhesive.

FIG. 8B illustrates an abrasive system 850, according to an example embodiment. The abrasive system 850 includes a housing 851 and a body 852 contained within the housing 851. The body 852 may include an electronic assembly 853 coupled to the body 952. The body 852, as illustrated, may be a particular type of edge grinding tool, wherein the workpiece 1961 may be a piece of glass. The housing 851 may further include coolant 854 that is applied to the grinding interface during a material removal operation. In one embodiment, the housing 851 may include at least one electronic device 855. The at least one electronic device 855 can be coupled to a surface or embedded in the material of the housing 851. The electronic assembly 853 includes one or more electronic devices configured to communicate with the one or more electronic devices 855 in the housing 851. Information received by the electronic device 855 may be related to a remote electronic device 856, which is positioned outside of the housing 851.

As further illustrated, the workpiece 861 may include one or more electronic devices 857 coupled to the workpiece 861 and configured to transmit and/or receive information from one of the other electronic devices, such as the electronic assembly 853, the electronic device 855, and/or the electronic device 856. In particular instances, it may be suitable that the electronic assembly 853 include a protective layer configured to protect against corrosive effects of the coolant 854.

In an alternative embodiment, the electronic assembly 853 may also be coupled to, partially embedded, or fully embedded, in a surface 858 of the body 852. The placement and position of the electronic assembly may facilitate improved communication with the electronic devices 855, 856, and/or 857. Moreover, in certain instances, of the electronic devices 855, 856, 857 and/or electronic assembly 853 may utilize a vertically polarized antenna, booster antenna, 3D polarized antenna, or any combination thereof. It will also be appreciated that in certain instances, it may be suitable to use a plurality of electronic assemblies located at different positions and orientations on the body 852.

### IV. Example Microscopic Interactions

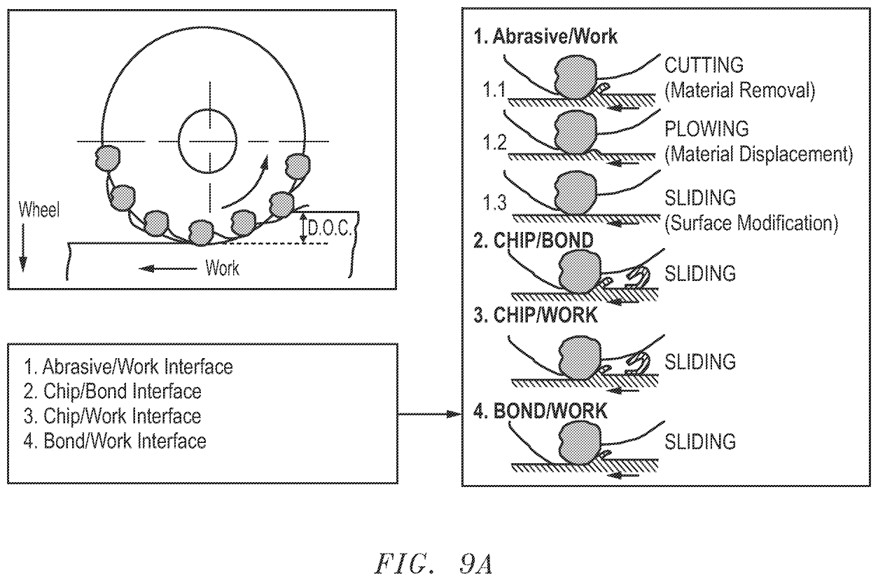

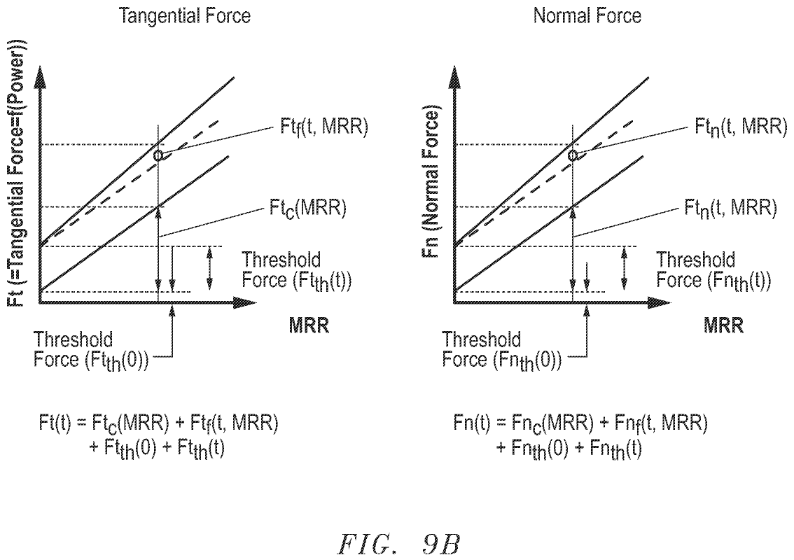

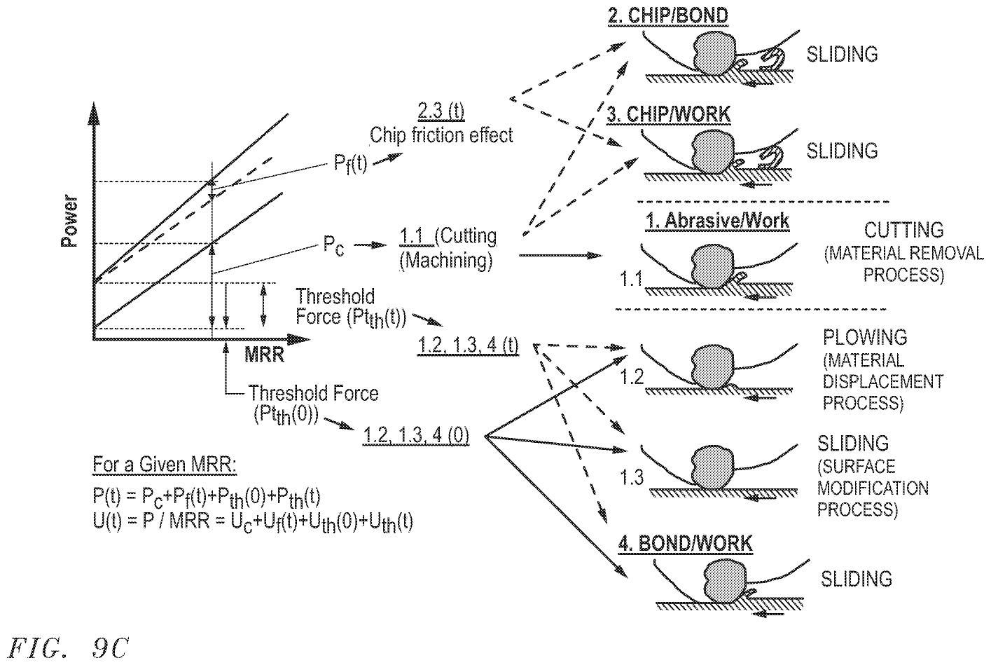

FIG. 9A depicts various types of interactions associated with grinding processes. Each type of interaction could be incorporated into the analytical models and/or machine learning methods and systems described herein. For example, an abrasive-type interaction could include cutting (material removal), plowing (material displacement), or sliding (surface modification) effects. Abrasion processes include sliding a hard material such as an abrasive grain, against a softer material, during which the softer material undergoes deformation and surface modification. In some cases, this may be due to deep scratches or plowing, such as work material being displaced without material removal or sliding between abrasive grain and work piece. If the depth of penetration of abrasive grains against the work material is sufficiently intense, then the abrasive grain can act as a cutting edge, leading to the generation of a fresh surface and removal of debris called “chips” from the work surface. If the depth of penetration is not sufficient, it is likely that the hard abrasive grain will locally deform the work material. This interaction or deformation is often termed as plowing. Finally, if the depth of penetration of abrasive grain against work material is extremely shallow, the result would be the sliding of abrasive grain against work material, although at high contact stress. The surface generated at the end is the cumulative effect of all these abrasive/work interactions during the grinding process. Additionally or alternatively, various chip/bond, chip/workpiece, bond/workpiece, and/or other sliding interactions are possible and contemplated.

FIG. 9B depicts example force interactions and associated analytical models on a grinding process. As an example, the material removal rate (MRR) could increase proportionally to the tangential force and/or the normal force. Furthermore, FIG. 9B illustrates MRR as a function of the components of applied force (e.g., tangential force Ft and normal force Fn), which follow relationships that are governed by the principles of machining and tribology. As an example, for a given material removal rate, tangential force Ft=the force required to form chips, Ft_{c}+frictional force, Ft_{f}+threshold force at time zero, Ftₕ(0)+threshold force at time t, Ftₕ(t). A similar relationship applies for the normal force component.

FIG. 9C depicts example power interactions and associated analytical models of a grinding process. For example, FIG. 9C illustrates the variation in grinding power after time “t” at a given MRR and its associated four components: (1) initial threshold power Pₜₕ(0), (2) change in threshold power with time Pₜₕ(t), (3) power for cutting or chip making P_{c}, and (4) change in P_{c} caused by chip friction effects, P_{f}(t). It should also be appreciated that FIGS. 9A-9C are presented as conceptual representations of example microscopic interactions and are not intended to be limiting with respect to the types of microscopic interactions, analytical models, or grinding processes that may be used in the current disclosure.

### V. Example Computing Devices

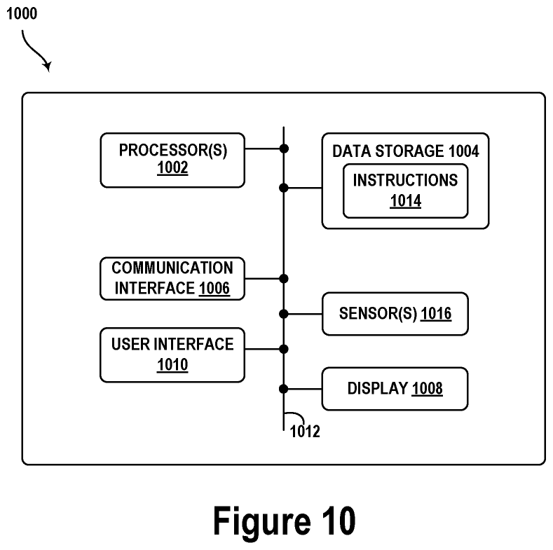

FIG. 10 illustrates a block diagram of a computing device 1000, according to an example embodiment. In particular, computing device 1000 can be configured to perform at least the functions related to the components of and/or related to analytics platform 1110, enterprise 1120, outside vendors 1130, 3^{rd} party users 1140, analytics system 1210, manual abrasive devices, wearable devices, automated abrasive devices, server devices, other sensors, abrasive products, remote devices, vendors, analytics platform microcontrollers, controllers, remote networks, client networks, mobile devices, and/or other elements described herein.

Computing device 1000 may include one or more sensors 1016 for collecting data, a data storage 1004, which may store the collected data and may include instructions 1014, one or more processor(s) 1002, a communication interface 1006 for communicating with a remote source (e.g., a server or another device/sensor), and a display 1008. Additionally, computing device 1000 may include an audio output device (e.g., a speaker) and a haptic feedback device (e.g., an eccentric rotating mass (ERM) actuator, linear resonant actuator (LRA), or piezoelectric actuators, among other examples).

Processor 1002 may include one or more general purpose processors or special purpose processors (e.g., GPUs). Processor 1002 may be configured to execute computer-readable instructions 1014. For example, processor 1002 may control the one or more sensors 1016 based, at least in part, on computer-readable instructions 1014. Processor 1002 may be configured to process the real-time data collected by the one or more sensors 1016.

Data storage 1004 is a non-transitory computer-readable medium that may include, without limitation, magnetic disks, optical disks, organic memory, and/or any other volatile (e.g. RAM) or non-volatile (e.g. ROM) storage system readable by the processor 1002. Data storage 1004 may include a data storage to store indications of data, such as sensor readings, machine learning models, program settings (e.g., to adjust behavior of the computing device 1000), user inputs (e.g., from a user interface on the device 1000 or communicated from a remote device), etc. Data storage 1004 may also include program instructions 1014 for execution by the processor 1002 to cause the device 1000 to perform operations specified by the instructions. The operations may include any of the methods described herein.

Communication interface 1006 may include hardware to enable communication within the computing device 1000 and/or between the computing device 1000 and one or more other devices. The hardware can include transmitters, receivers, and antennas, for example. Communication interface 1006 can be configured to facilitate communication with one or more other devices, in accordance with one or more wired or wireless communication protocols. For example, the communication interface 1006 can be configured to facilitate wireless data communication for computing device 1000 according to one or more wireless communication standards, such as one or more IEEE 801.11 standards, ZigBee standards, Bluetooth standards, etc. For instance, communication interface 1006 could include WiFi connectivity and access to cloud computing and/or cloud storage capabilities. As another example, communication interface 1006 can be configured to facilitate wired data communication with one or more other devices.

Display 1008 can be any type of display component configured to display data. As one example, display 1008 can include a touchscreen display. As another example, the display 1008 can include a flat-panel display, such as a liquid-crystal display (LCD) or a light-emitting diode (LED) display.

User interface 1010 can include one or more pieces of hardware used to provide data and control signals to computing device 1000. For instance, user interface 1010 can include a mouse or a pointing device, a keyboard or a keypad, a microphone, a touchpad, or a touchscreen, among other possible types of user input devices. Generally, user interface 1010 can enable an operator to interact with a graphical user interface (GUI) provided by computing device 1000 (e.g., displayed by the display 1008). As an example, user interface 1010 may allow an operator to provide input data to computing device 1000. As another example, the operator may provide an input indicative of a product to be used to perform the operation and/or an input indicative of a workpiece on which the operator may perform the abrasive operation.

In some embodiments, a user could utilize the GUI to provide a desired operation level (e.g., maximum desired vibration level, maximum desired noise level, etc.), which could be based on, for example, user preference and/or user comfort. It will be understood that a user could provide information indicative of the desired operation level by other means as well.

One or more sensors 1016 may be configured to collect data in real-time from or associated with an environment of the computing device 1000. Real-time collection of data may involve the sensors periodically or continuously collecting data. For example, the one or more sensors 1016 may include a sound detection device (e.g., a microphone) that is configured to detect sound in the environment of the sensor (e.g., from an abrasive device operating in proximity of the sensor). Additionally and/or alternatively, the sensors 1016 may be configured to collect data from or associated with an operator of computing device 1000. For example, the one or more sensors 1016 may include an accelerometer. As described herein, the data collected by the one or more sensors 1016 may be used to determine abrasive operational data, which could then be used for obtaining real-time data about grinding/abrasive operations, capturing a user experience of a user that is using the device, and/or determining operational and/or or enterprise improvements (e.g., based on data collected over a period of time).

The one or more sensors 1016 may also include other sensors for detecting movement, such IMUs and gyroscopes. Further, the one or more sensors 1016 may include other types of sensors such as location-tracking sensors (e.g., a GPS or other positioning device), light intensity sensors, thermometers, clocks, force sensors, pressure sensors, photo-sensors, Hall sensors, vibration sensors, sound-pressure sensors, a magnetometer, an infrared sensor, cameras, and piezo sensors, among other examples. Sensors and their components may be miniaturized.

### VI. Example Analytics Platforms

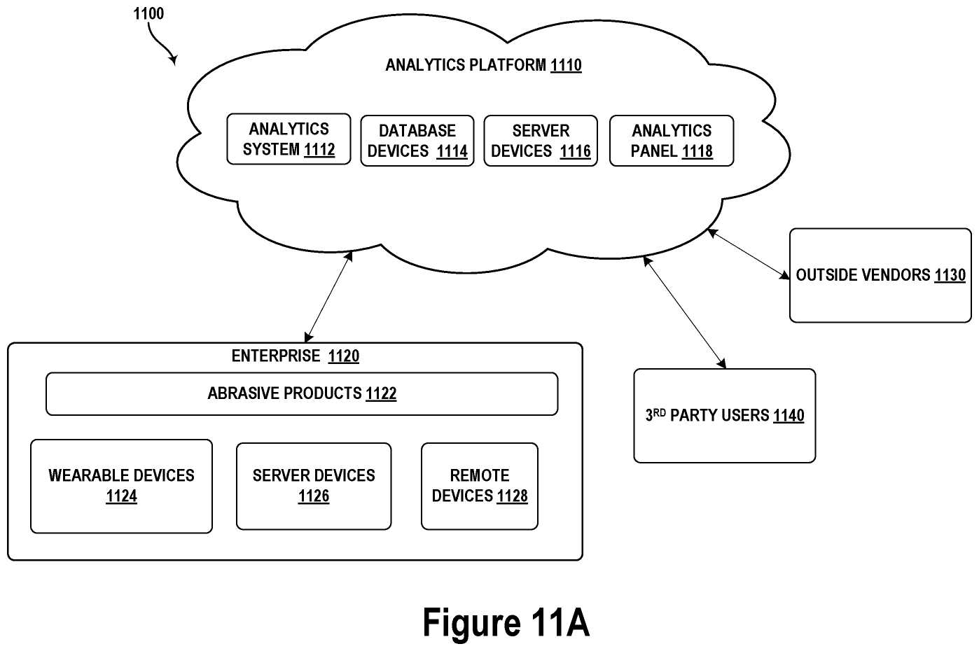

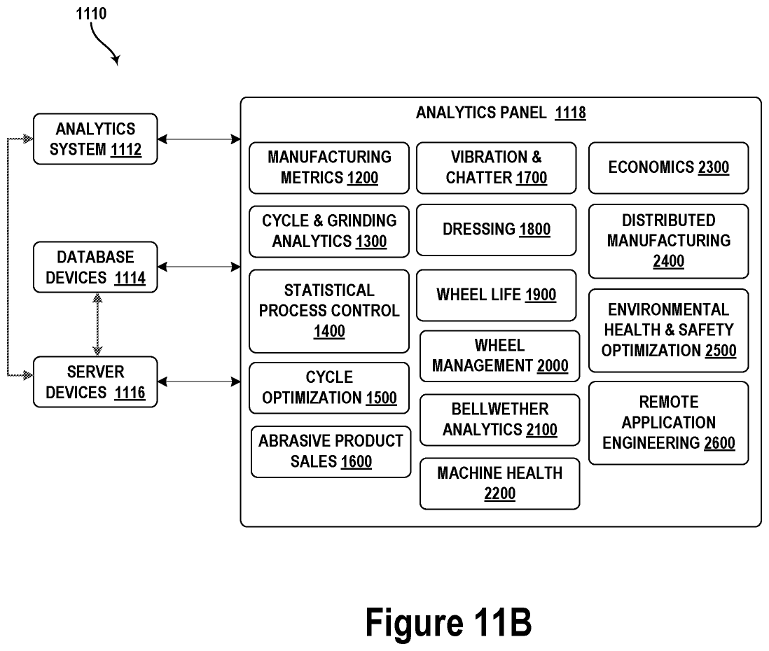

FIG. 11A illustrates arrangement 1100 of analytics platform 1110, according to an example embodiment. As shown in FIG. 11, analytics platform 1110 may be communicatively coupled to enterprise 1120, outside vendors 1130, and 3^{rd} party users 1140. Analytics platform 1110 may include, for example, analytics system 1112, database devices 1114, and server devices 1116, and analytics panel 1118. Analytics platform 1110 may utilize a variety of data analysis algorithms to process and/or analyze the sensor data collected by the enterprise 1120. Analytics platform 1110 may store the received sensor data and then analyze the data to provide product-specific information of the abrasive products and/or workpiece-specific information associated with an abrasive product on enterprise 1120. As used herein, product-specific information may refer to any information related to elements of an abrasive product/device or elements of any abrasive operations/processes performed by the abrasive product/device. For example, analytics platform 1110 may determine best operational practices for enterprise 1120. In another example, the analytics platform 1110 may determine different value metrics (e.g., productivity, product life, etc.) for different abrasive products. As used herein, abrasive product may refer to an apparatus associated with or embodied by an abrasive tool.

Analytics system 1112 may include one or more data analytics algorithms (e.g. peak detection, unsupervised machine learning models) configured to receive sensor data from enterprise 1120. For example, sensor data may be related to an abrasive product and correlated with a grinding operation mode, a particular workpiece, a particular abrasive tool, or a particular grinding condition from enterprise 1120. In response to receiving the sensor data, analytics system 1112 may analyze the data to extract relevant information (e.g. peaks, points above a certain threshold, etc.) and/or organize the data to be more compact and easily processed. In some cases, analytics system 1112 may apply an unsupervised model to extract patterns and derive conclusions on the system. As described herein, the predicted condition could trigger, prompt, or initiate various events such as a notification, a report, an order, or another type of action.

Database devices 1114 may include one or more computing devices configured to store data into one or more databases. For example, database devices 1114 may include one or more relational databases (e.g., SQL), graph databases (e.g., neo4j), document databases (e.g., MongoDB), column databases (e.g., Cassandra), and/or other database models. Additionally or alternatively, database devices 1114 could include time-series data, such as TimescaleDB. Database devices 1114 may reside on a server, cloud, and/or on an edge device. For example, a database device 1114 residing on an edge device could be utilized for short term storage and provide rapid feedback to the machine or user/customer. In such scenarios, a database device 1114 residing at the edge device could reduce or eliminate the delay that could be involved in transferring messages back and forth from a cloud server, other remote computing devices, etc. Database devices 1114 may act as data storage for components of analytics platform 1110. An as example, database devices 1114 may be configured to receive and store sensor data from enterprise 1120 and provide the sensor data to analytics system 1112 for incorporating into the user interface of a dashboard and/or analyzing. In some examples, data devices 1114 may be configured to use tools, such as big data analytics platforms, cloud infrastructure automation tools, or the like, or any combination thereof, to facilitate faster data transfer and/or real-time analytics. Exemplary tools may include AWS Kinesis, Kafka, Azure Data Explorer (ADX), Google BigQuery, Elasticsearch, or the like, or any combination thereof. In some examples, database devices 1114 may be configured to act as the primary data source for analytics panel 1118.

Server devices 1116 may include one or more web servers, file servers, and/or computational servers. Server devices may facilitate communication between analytics platform 1110 and enterprise 1120, outside vendors 1130, and 3^{rd} party users 1140. Communication may be facilitated by known web communication protocols, such as TCP/IP. In some embodiments, server devices 1116 may be utilized by analytics system 1112 or analytics panel 1118 for computational tasks. For example, devices in server devices 1116 may be part of a MapReduce cluster that is used as part of a distributed training architecture for analytics system 1112.

Analytics panel 1118 may include a web or local application configured to utilize information collected from analytics system 1112 and database devices 1114. After processing the collected information, analytics panel 1118 could generate various predicted future conditions for enterprise 1120 as well as various prescriptive actions for enterprise 1120. As used herein, a predicted future condition refers to an estimate about a future event that could occur at enterprise 1120. Examples of future events may include a predicted failure of an abrasive product/workpiece, a prediction of potential damage to an abrasive product/workpiece, or a prediction that the quality of a workpiece does not meet a predetermined quality level, among other possibilities. Further, as used herein, a prescriptive action refers a recommendation of a best course of action given a current state and/or current situation of an abrasive product and/or given a current state and/or current situation of enterprise 1120. Examples of prescriptive actions may include a command to shut off an abrasive product if the abrasive product is displaying aberrant behavior, a command to adapt the speed rate of an abrasive wheel, a notification to change an abrasive article of an abrasive product, or a notification to dress a damaged abrasive product, among other possibilities.

In some embodiments, analytics panel 1118 includes a simulation environment programmed with digital versions (e.g., “digital twins”) of physical abrasive products used by enterprise 1120. The simulation environment could use these digital versions to estimate productivity, costs, and/or injuries resulting from adding/reconfiguring/removing different digital abrasive products from the stimulation environment. In some embodiments, analytics panel 1118 is configured to graphically display metrics associated with one or more abrasive products and/or one or more workpieces in enterprise 1120.

Notably, the configuration of analytics platform 1110 is provided as an example. In some cases, analytics platform 1110 may include one or more additional devices. For example, analytics platform 1110 may include a firewall to allow access from authorized users, deny access from unauthorized users, provide intrusion detection, facilitate virus scanning, and/or provide other network security services. As another example, analytics platform 1110 may include one or more load balancers to distribute incoming network traffic or requests across multiple computing devices within analytics platform 1110 (e.g., such that no single devices is overwhelmed with task requests). In some embodiments, load balancing could be performed among a set of grinding machines. In such scenarios, data analytics could be utilized to correctly balance load among the grinding machines. In other examples, analytics platform 1110 may include one or more routers, virtual machines, proxy servers, and/or other common network devices. Analytics platform 1110 may also be connected to one more client devices (e.g., personal computers or mobile phones). In some examples, analytics platform 1110 may offer virtual private network (VPN) services.

Additionally and/or alternatively, components of analytics platform 1110 may be replicated across multiple computing devices to provide data duplication and increase capacity of services. These computing devices may be located at different physical locations to ensure high availability in case of failure at one location. As such, analytics platform 1110 may be configured across different physical locations and hundreds of computing devices.

Enterprise 1120 may include, for example, one or more abrasive products 1122, wearable devices 1124, server devices 1126, and remote devices 1128. Enterprise 1120 may represent a single geographic location containing multiple abrasive machines or may represent multiple abrasive machines located across several geographic locations. Moreover, enterprise 1120 may represent a single enterprise of a plurality of enterprises that utilize products manufactured or maintained by the entity operating analytics platform 1110. As such, analytics platform 1110 may act as a remote customer support system for these products. Alternatively, analytics platform 1110 may be, in part or in whole, on a computing device of enterprise 1120 and act as a local customer support system. For example, unsupervised machine learning models included in analytics system 1112 may be on enterprise 1120, such that server devices 1126 may analyze sensor data locally from, for example, wearable devices 1124 or abrasive products 1122 and correlated with a grinding operation mode, a particular workpiece, a particular abrasive tool, or a particular grinding condition. In such cases, enterprise 1120 may nevertheless send data from analytics platform 1110, abrasive products 1122, wearable devices 1124, server devices 1126, and remote devices 1128 to the entity that directly or indirectly manufactured products that enterprise 1120 uses (e.g. abrasive products 1122, wearable devices 1124, etc.).

Abrasive products 1122 may include one or more devices or tools that perform grinding operations on a workpiece. As described above, abrasive products 1122 may be manufactured or maintained by the entity operating analytics platform 1110. Abrasive products 1122 may contain one or more sensors that collect abrasion operational data associated with grinding operations or the involving the workpiece being grinded on. For example, the one or more sensors may transmit the collected abrasion operational data, via Bluetooth, TCP/IP or other networking protocols, to server devices 1126. In another example, the one or more sensors may transmit the collected abrasion operational data to analytics platform 1110.

Wearable devices 1124 may include wearable computing devices with one or more sensors that continuously or periodically collect data from or associated with an environment of abrasive products 1122 and/or data from or associated with operators' abrasive products 1122. For example, the data collected by the wearable devices 1124 may be used to determine abrasive operational data. In some examples, the collected data may be sent to server devices 1126, for example, via Bluetooth, TCP/IP, or other networking protocols. In other examples, the collected data may be transmitted directly to analytics platform 1110.

Server devices 1126 may include one or more computing devices located on enterprise 1120. Server devices may be configured to receive and aggregate sensor data from abrasive products 1122 and wearable devices 1124. Server devices 1126 may be operated by analytics platform 1110 or by enterprise 1120. Upon receiving sensor data, server devices 1126 may apply data filters to the sensor data, such as removing outlier sensor data and/or ignoring sensor data from one or more wearable devices 1124 or abrasive products 1122. In some examples, server devices 1126 may be configured to convert sensor data into a different data format more suitable for analytics platform 1110, for example into JavaScript Object Notation (JSON). As another example, server devices 1126 may allow a human operator to tag sensor data with labels, as further described herein. Server devices 1126 may receive product-specific information and/or workpiece-specific information from analytics platform 1110 and distribute this information to remote devices 1128, abrasive products 1122, wearable devices 1124, or may store this data for later access by members of enterprise 1120.

In some embodiments, server devices 1126 may provide sensor data to analytics platform 1110 by grouping data in batches. Batches may be transmitted periodically, for example, every 10 minutes or 30 minutes. In other examples, server devices 1126 may send sensor data to analytics platform 1110 in a real time, streaming format. Additionally or alternatively, data received from the sensor devices 1126 and/or controller could be obtained at any data transfer rate. Furthermore, the received data could be stored at an edge device and/or transmitted to a remote server using various data compression/data transmission techniques. In some embodiments, server devices 1126 may be configured to monitor the sensors disposed in abrasive products 1122 and wearable devices 1124. For example, server devices 1126 may send heartbeat messages to the sensors, which in turn may be configured to respond with a response heartbeat message. This may ensure that sensors are operable and have not stopped sending data to server devices 1126, for example, because of malfunction or loss of power.

Remote devices 1128 may include interfaces located on one or more computing devices in enterprise 1120. For example, remote devices 1128 may include on wearable devices (e.g., smart watches), mobile devices (e.g., mobile phones or tablets), and/or monitors (e.g., computer screens). Remote devices 1128 may receive data from server devices 1126 or analytics platform 1110 and display output data on a graphical user interface (GUI) or emit an alarm, an alert, a notification, a report, an order, and/or another type of action.

Outside vendors 1130 may represent one or more computing systems managed by partners of the entity operating analytics platform 1110. In example embodiments, analytics platform 1110 may transmit to outside vendors 1130 new order requests, delivery requests, and/or other logistics requests based on predictions made by analytics system 1112. These requests may be made automatically by analytics platform 1110 on the behalf of enterprise 1120.

3^{rd} party users 1140 may include one or more individuals or organizations that utilize the capabilities of analytics panel 1118. For example, 3^{rd} party users 1140 may access analytics panel 1118 via a web browser and may be able to access data provided to analytics panel 1118 by analytics platform 1110. 3^{rd} party users 1140 may be granted access, for example, through a subscription based model. Analytics panel 1118 may provide multiple levels of access to 3^{rd} party users 1140, each based on the subscription purchased by 3^{rd} party users 1140. For example, each level of access may provide more sensitive or larger amounts of data.

Notably, the components of arrangement 1100 are used for the purpose of example. Other components and arrangements are possible.

FIG. 11B illustrates internal communications of analytics platform 1110, according to an example embodiment. As stated above, analytics platform 1110 may include analytics panel 1118, analytics system 1112, database devices 1114, and server devices 1116. As mentioned above, analytics platform 1110 may be maintained by an entity manufacturing abrasive products 1122, an entity which hereafter may be referred to as manufacturing entity, or outside vendors 1130. Similar analytics platforms may be used across several enterprises, accessible to enterprises (e.g. enterprise 1120) and the manufacturing entity. Data collected from different enterprises may be stored on separate databases or the same databases, but the entirety of the data and the respective data analytics from different enterprises may only be fully accessible to the manufacturing entity.

Analytics panel 1118 may include manufacturing metrics panel 1200, cycle & grinding analytics panel 1300, statistical process control panel 1400, cycle optimization panel 1500, abrasive product sales panel 1600, vibration & chatter panel 1700, dressing panel 1800, wheel life panel 1900, wheel management panel 2000, bellwether analytics panel 2100, machine health panel 2200, economics panel 2300, distributed manufacturing panel 2400, environmental health & safety optimization panel 2500, and remote application engineering panel 2600.

It will be understood that other types of analytical panels are possible and contemplated. For example, analytics panel 1118 could include an original equipment manufacturer (OEM) interaction panel. In such scenarios, the OEM interaction panel could provide a beneficial data/analytics link with one or more OEM enterprises so as to aide users and third-party customers. Additionally or alternatively, the analytics panel 1118 could include a part quality panel that may utilize machine vision information to provide details pertaining to part quality. In such scenarios, images of produced parts, metrology measurements, and other information could be analyzed and/or synthesized so as to provide information to a user regarding part throughput, part quality, typical mis-manufacturing issues, etc.

Each element of analytics platform 1110 will be discussed in further detail in the following sections. However, the features of each panel within analytics panel 1118 may be rearranged as necessary as an amendment of the same panel or as a different panel. Further, analytics panel 1118 may incorporate more or less panels with arrangements of the same features as necessary. Each element in analytics panel may be available to enterprises, e.g. 1120, and/or deployed on server devices 1126 as an alternative to server devices 1116. Although each panel may be part of analytics panel 1118, they may incorporate data analysis algorithms and models of analytics system 1112, with each panel perhaps incorporating several data analysis algorithms and models of analytics system 1112. Additionally, data analysis algorithms and models of analytics system 1112 may be reused as necessary throughout each panel of analytics panel 1118. In some embodiments, the data presented in the analytics platform 1110 could be generated and/or determined based on an artificial intelligence model and/or a machine learning model. Additionally or alternatively, the data presented in the analytics platform 1110 described herein could be based on a user category (e.g., OEM user, admin user, management user, third-party user, etc.) and/or user level (e.g., worker user, staff user, management user, supervisor user, superuser, etc.).

Panels of analytics panel 1118 may incorporate analyzed data from analytics system 1112 and raw data from database devices 1114. As mentioned above, raw data may be received from wearable devices 1124 or abrasive products 1122 and stored in database devices 1114. In some panels of analytics panel 1118, raw data retrieved from database devices 1114 may be displayed as a chart, line plot, or other type of data visualization method. Raw data from database devices 1114 may also be analyzed using algorithms and models from analytics system 1112, the computations for which may be done on server devices 1116, or in other words, server devices 1116 may be configured to receive data from database devices 1114 and configured to analyze the data using algorithms and/or models from analytics system 1112. The analyzed data may be provided to analytics panel 1118, which may be configured to display the analyzed data as a chart, line plot, bar chart, or other type of data visualization method, along with alerts and other summarized information. Server devices belonging to enterprise 1120, e.g. server devices 1126, may also be configured to receive data, algorithms and models and analyze data received from analytics platform 1110. The methods/algorithms of analytics system 1112 as well as the data visualization methods and summarized information will be discussed in subsequent sections on analytics panel 1118.

Further, server devices 1116 may be configured to serve as host to panels of analytics panel 1118. These server devices may be same or different server devices used to analyze data according to models and algorithms supplied by analytics system 1112, including server devices 1126 of enterprise 1120.

In some examples, a user from enterprise 1120 may request to view manufacturing metrics panel 1200 of analytics panel 1118, which may initiate a request at server devices 1116 for relevant analyzed data and analytics system 1112 for relevant raw data. Server devices 1116 may request from database devices 1114 relevant data belonging to enterprise 1120, as well as relevant algorithms/models from analytics system 1112. After analyzing, server devices 1116 may send the analyzed data to analytics panel 1118 and analytics panel 1118 may arrange the raw and analyzed data in a human readable format.

In other examples, a user from enterprise 1120 may request to view manufacturing metrics panel 1200 of analytics panel 1118, initiating a request at server devices 1116. Server devices 1116 may receive both the raw data intended for analytics panel 1118 and raw data intended to be analyzed, as well as algorithms/models from analytics system 1112. The data may be analyzed in accordance with the algorithms/models and the analyzed and raw data may be sent by server devices 1116 to analytics panel 1118, where both data may be arranged to be able to be displayed in human readable format. Alternatively, server devices 1116 may arrange both raw and analyzed data to be able to be displayed in human readable format, which may be sent (encrypted or not) to analytics panel 1118, where the same or similar human readable format may be displayed. The raw and analyzed data in human readable format may be displayed on a web-based application or through an application running on a local computer

### VII. Manufacturing Metrics Panel

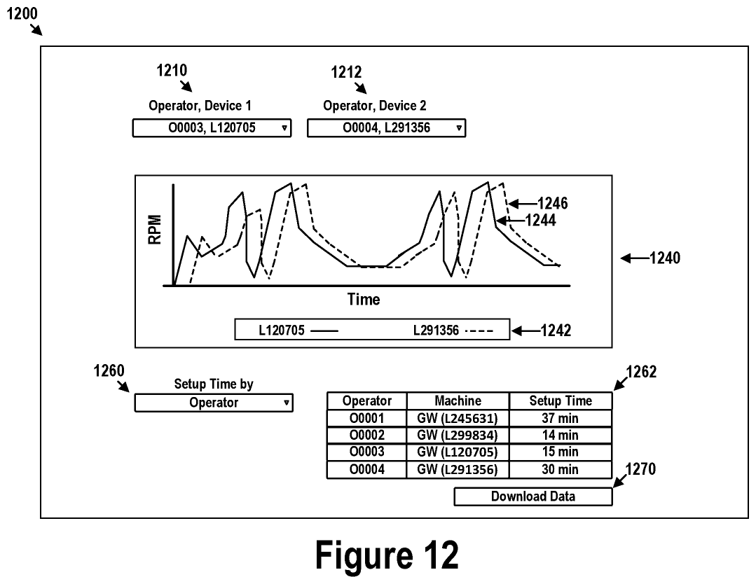

As mentioned above, analytics panel 1118 may include manufacturing metrics panel 1200, which may be a website or software platform that provides manufacturing metrics to the users at enterprise 1120 and/or the entity directly or indirectly manufacturing abrasive products 1122, wearable devices 1124, etc. FIG. 12 illustrates an example of manufacturing metrics panel 1200. Manufacturing metrics panel 1200 may include a variety of data and data analysis results that may be useful to enterprise 1120 in optimizing operations. In some embodiments, manufacturing metrics panel 1200 could display a comparison of similar jobs on different machines and/or a summary of set up times by machines, however, manufacturing metrics dashboards may include many other operations, as will be outlined below.

To compare similar jobs on different machines, manufacturing metrics panel 1200 contains field 1210 and field 1212, as well as plot 1240. Field 1210 and field 1212 may include as options a list of sensor data collected from abrasive products 1122, wearable devices 1124, and/or the environment in which they are being used. The selected options of field 1210 and field 1212 may determine the information displayed on plot 1240. Plot 1240 may include a plot of multiple data points and information on each line. In this example, Plot 1240 includes line 1244 and line 1246 and additionally includes a key for what each line displays in legend 1242. Information plotted in plot 1240 may include data collected from the selected sensor representing a particular process in the past or in the present as well as predicted data points in the future based on data in the past and/or present. For example, data may be sent through a variety of wireless or wired communication protocols as mentioned above (e.g. IEEE 801.11 standards, ZigBee standards, Bluetooth standards) and a computing device running manufacturing metrics panel 1200 may display real time data received from data sent from a selected sensor. Although example manufacturing metrics panel 1200 may display two fields to plot in chart, manufacturing metrics dashboards may have the ability to only display one process and/or overlay information collected on multiple (e.g. more than two) processes.

To summarize of setup times by machine, manufacturing metrics panel 1200 includes field 1260 and summary 1262, which, similar to comparing similar jobs on different machines, may be derived by data sent by a computing device of and/or sensors on abrasive products 1122, wearable devices 1124, and/or the environment in which they are being used. For example, an operator may need to setup a machine for use at the beginning of their shift. The operator may log into a computing device at a certain time to begin setting up the device and the device may report to be running 15 minutes later. It may be determined that the operator took 15 minutes to setup the machine and this datapoint may be sent to a computing device running manufacturing metrics panel 1200. Alternatively or additionally, the datapoint may be stored on a database of enterprise 1120 and manufacturing metrics panels and other panels of analytics platform 1110 may request for the exact datapoint or a summary of all the datapoints in a database. If the operator took longer than expected to setup the machine (e.g. if the actual setup time is greater than the expected setup time), then the computing device on the machine may send an alert to server devices 1116 or server devices 1126. The alert may be incorporated into a panel of analytics panel 1118 or may be displayed on a device of remote devices 1128. Upon determining that the operator took longer than expected, another operator of enterprise 1120 may be notified (through the alerts mentioned previously or through another manner) that the operator is having difficulty and that they should show the operator how to setup the machine more efficiently. In other examples, a repository of standard operating procedure (SOP) videos may be stored in database devices 1114, server devices 1116, server devices 1126, and/or locally on a computing device. Upon determining that the operator took longer than expected, the computing device and/or server devices 1126 may retrieve at least one of the SOP videos to display to the operator so that in the future, the operator may setup the machine more efficiently.

Field 1260 of manufacturing metrics panel 1200 may include options to display the setup time by operator, machine, time, etc. Summary 1262 may include a summary of the setup times in accordance to the settings determined by field 1260. In some examples, field 1260 may be set to display the setup time by operator, and summary 1262 may therefore be set to be organized by operator. Other metrics collected throughout the day, for example downtime, may also be reported to the computing device running manufacturing metrics panel 1200, and displayed similar to summary 1262. Manufacturing metrics panel 1200 may also have option 1270 to download data reported from remote machines to a local machine.

For the purpose of simplicity, manufacturing metrics panel 1200 as displayed may only demonstrate two potential capabilities of a manufacturing metrics dashboard, however, many other possibilities exist. Some other potential capabilities of a manufacturing metrics dashboard may include the ability to (1) show long term trends of manufacturing efficiency metrics, (2) compare manufacturing efficiency metrics across machines/devices to assist in load balance, (3) show operator efficiency variations, (4) display one time view of real time status of key metrics across the manufacturing floor as measured against targets set by management, (5) show a summary of setup time by machines, operators, jobs, etc., (6) show quality metrics (comparison of scrap rate, process capability index, rework, and first pass yield metrics across all machines daily or over a period of time), (7) compare parts across all machines/devices over a period of time (including good parts, expected parts, scrapped parts, rejected parts, etc.), (8) display work shift to work shift variation, among other operations. In some examples, machines may run the same or similar jobs. These jobs across different machines may be analyzed by analytics system 1112 and the analysis and/or raw data may be displayed on manufacturing metrics panel 1200 so that the user may compare job metrics (for example, efficiency) across multiple machines. In further examples, a machine may run several different jobs. These jobs may likewise be compared and analyzed by analytics system 1112 and the analysis and/or raw data may be displayed on manufacturing metrics panel 1200 so that the user may compare job metrics on the same machine. An operator of enterprise 1120 and/or other member of enterprise 1120 may utilize this information to make more informed decisions relating to machine and/or enterprise operations.

Manufacturing metrics panel 1200 may include the ability to show long term trends across of manufacturing efficiency metrics and show comparisons between manufacturing efficiency metrics across machines/devices to assist in load balance. Manufacturing efficiency metrics may include worker output rates, shop floor productivity metrics, machine utilization, among others, the values of which may be calculated on server devices 1116 or server devices 1126 and stored in database devices 1114 before runtime, then gathered upon request of manufacturing metrics panel 1200. Alternatively, server devices 1116 or server devices 1126 may calculate manufacturing efficiency metrics upon request of manufacturing metrics panel 1200. These manufacturing metrics may be computed with data collected over a long span of time to obtain long term trends. If manufacturing efficiency metrics are calculated prior to request of manufacturing metrics panel 1200, an organized list of manufacturing efficiency metrics may be obtained across devices on request of manufacturing metrics panel 1200. Alternatively, manufacturing efficiency metrics may be calculated and compared on request. Information from these long term trends and comparisons may enable a user from enterprise 1120 to more effectively make decisions.

As mentioned above, manufacturing metrics panel 1200 may also show operator efficiency variations, which may be stored in a similar manner to manufacturing efficiency metrics. Operator efficiency variations may be calculated upon request of analytics platform 1110 by server devices 1116 or server devices 1126. Alternatively, operator efficiency variations may be calculated periodically by server devices 1116 or server devices 1126 and stored in a database, such as database devices 1114, and retrieved upon request.

Manufacturing metrics panel 1200 may also display one time view of real time status of key metrics across the manufacturing floor as measured against targets set by management. In this case, data sent to database devices 1114 from wearable devices 1124 or abrasive products 1122 may be sent directly to server devices 1116, or alternatively, be sent to database devices 1114 for storage before being sent to server devices 1116. A plot or chart already displayed on manufacturing metrics panel 1200 may be updated according to the data received or regenerated in the entirety, incorporating received data.

Additionally, manufacturing metrics panel 1200 may show a summary of setup time by machines, operators, jobs, etc. These metrics may be calculated and stored similar to the method mentioned above. Data may be received by database devices 1114 and periodically, server devices 1116 may calculate the relevant metrics based on the sensor data received and send the metrics to database devices 1114 for storage. Upon request from manufacturing metrics panel 1200, the relevant metrics may be gathered from database devices 1114 and displayed in manufacturing metrics panel 1200. Alternatively, database devices 1114 may be updated with raw data, which may be retrieved and used to calculate the setup time by machines, operators, jobs, etc. In other examples, setup time may be raw data collected from sensors associated with abrasive products 1122 or wearable devices 1124 and stored in database devices 1114. Upon request, server devices 1116 may organize the data by machines, operators, jobs, etc. and display the data on manufacturing metrics panel 1200.

Manufacturing metrics panel 1200 may also include quality metrics, for example comparisons of scrap rate, process capability index, rework, and first pass yield metrics across all machines daily or over a period of time. Scrap rate may measure failed productions of a product relative to the total, where the failed productions of the product cannot be restored. Process capability index may measure the ability to produce within specification limits, perhaps defined by a customer of enterprise 1120 or a manager of enterprise 1120. First pass yield metrics may measure the production and quality performance, in this case over machines daily or over a period of time. These metrics may be deduced from data collected from sensors associated with abrasive products 1122, wearable devices 1124, or enterprise 1120 and may be displayed on manufacturing metrics panel 1200 as plots, graphs, or numbers, depending on the situation and metric.

Additionally, manufacturing metrics panel 1200 may include comparisons of parts across all machines/devices over a period of time (including good parts, expected parts, scrapped parts, rejected parts, etc.) and displays of shift to shift variation. Comparisons of parts may comprise determining the life of the parts, counting the number of each respective category of parts, among other operations. This data may be manually entered by users in enterprise 1120 and sent to analytics platform 1110 similarly to sensor data, or the data may be collected by sensors configured to discern the status of a part. Upon request of manufacturing metrics panel 1200, the data may be retrieved from database devices 1114.

### VIII. Cycle and Grinding Analytics Panel

Analytics platform 1110 may additionally include cycle and grinding analytics panel 1300, which may be a real-time measurement and monitoring tool for signals coming out of the controller of a machine. In an example embodiment, analytics platform 1110 may be configured to access data directly from one or more processor register, which may help provide real-time analytics of data received by the controller. Such data may include, for example, information related to machine state, part count, and/or sensor data that may be sent to the controller. In a particular example, a vibration sensor may be configured to monitor vibration of the machine and send vibration information to the controller, and reading vibration data directly from register may help provide real-time analytics of machine vibration. In examples, server devices 1116 may be programmed to read data register. Additionally or alternatively, external sensors may provide information to the cycle and grinding analytics panel 1300 about vibration, electrical current draw, images, video, temperature, etc. The grinding cycle(s) could be determined based on such information, which could be received from a controller or such external sensors. In some examples, analytics and/or machine learning/artificial intelligence models could be utilized with such data sources to identify grinding cycles, eliminate false positives, identify signals, etc. A cycle and grinding analytics panel 1300 may be maintained by the enterprise directly or indirectly manufacturing abrasive products 1122 and/or maintaining analytics platform 1110 and may provide users with the ability to make more informed decisions by providing an array of data and data analytics tools.

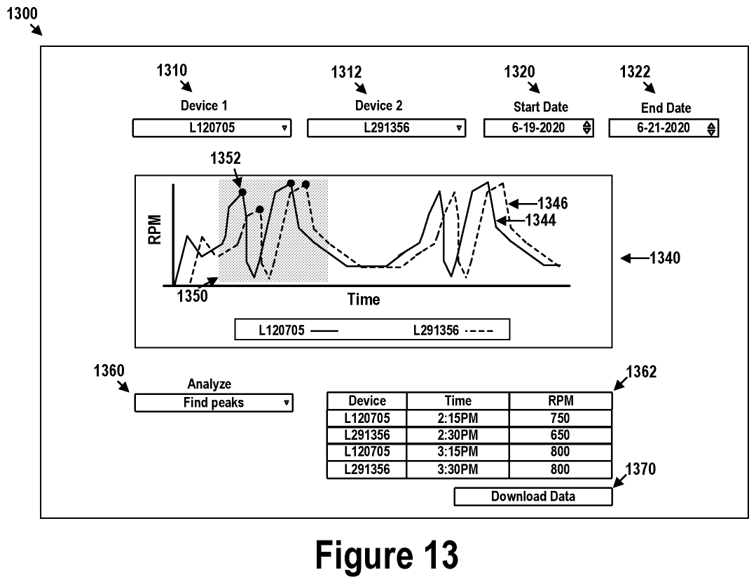

FIG. 13 illustrates an example of cycle and grinding analytics panel 1300, which may include the ability to (1) superimpose cycles from any machine, time range, job, etc., (2) analyze selected portions of the grinding cycle, (3) compute metrics such as average, peak, etc. (and other metrics as requested by engineers), (4) ability to annotate, pan, and download data, among others. Cycle and grinding analytics panel 1300 may also provide functionality such as displaying multiple signals superimposed on a plot such that a user may analyze the signals more efficiently, allowing an operator to add comments and/or notes on which signals to be stored and retrieved for further analysis, and displaying the operating conditions and the presently running job to analyze grinding cycles. Each signal from the machine may be manually analyzed by an operator/user or automatically analyzed by a program in addition to being analyzed independently or in conjunction with other signals.

Cycle and grinding analytics panel 1300 may include fields to select portions of a grinding cycle from varying devices (e.g. through field 1310, field 1312, field 1320, field 1322), plot 1340 displaying superimposed cycles from two devices, an analysis panel involving field 1360 and chart 1362, and button 1370 allowing downloads of summaries of data and/or raw data. Field 1310 and field 1312 may include selections of devices connected to or associated with enterprise 1120. Field 1320 and field 1322 may include options to plot a certain time range during which the devices selected by field 1310 and field 1312 were in progress. Other fields for other metrics (e.g. jobs) may also be present.

Plot 1340 may graph the data associated with devices selected in field 1310 and field 1312 in the time frame specified by field 1320 and field 1322 such that line 1344 may be associated with the device selected in field 1310 and line 1316 may be associated with the device selected in field 1346, both lines being limited to the time frame of field 1320 and field 1322. A user navigating plot 1340 may have the ability to annotate, pan, and download data manually or automatically.

Cycle and grinding analytics panel 1300 may also include an analysis panel involving field 1360 and chart 1362. Field 1360 may include options to select metrics to be computed from data displayed in plot 1340, e.g. average values, peak values, peak to peak values, slope or integral of a signal, etc. Plot 1340 may include selection 1350, which may be used to select a region from which the analysis is derived. Upon selection of field 1360, relevant portions of plot 1340 may be annotated (e.g. peak 1352) and chart 1362 may be shown, both of which are based on the selection from field 1360. A user using cycle and grinding analytics panel 1300 may use button 1370 to download chart 1362, data displayed in plot 1340, and plot 1340.

In some examples, enterprise 1120 may employ cycle and grinding analytics panel 1300 for statistics that may be utilized with a plurality of devices (e.g., a fleet of abrasive/grinding devices) to make more informed decisions. From cycle and grinding analytics panel 1300, a user within the enterprise may determine that the second process occurring in the region of selection 1350 may necessitate an excessive rotations per minute value. The user may then decide to use a larger grit size abrasive product or make another targeted decision based on the data displayed.

### IX. Statistical Process Control Panel

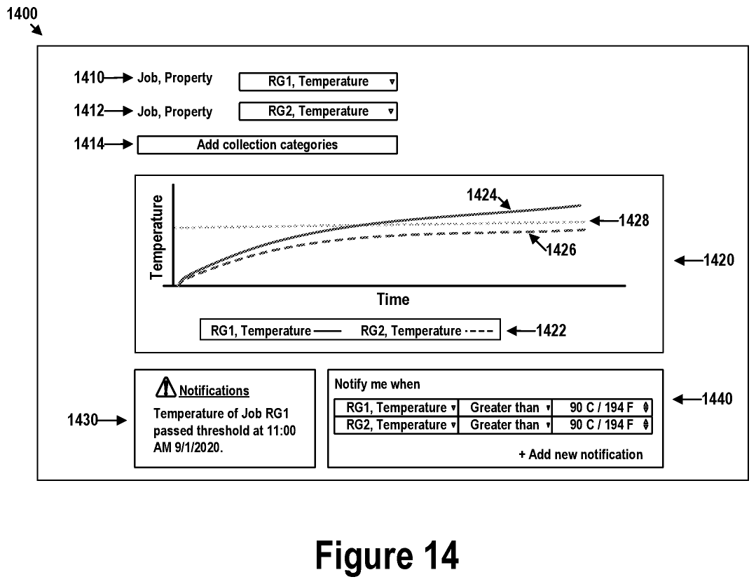

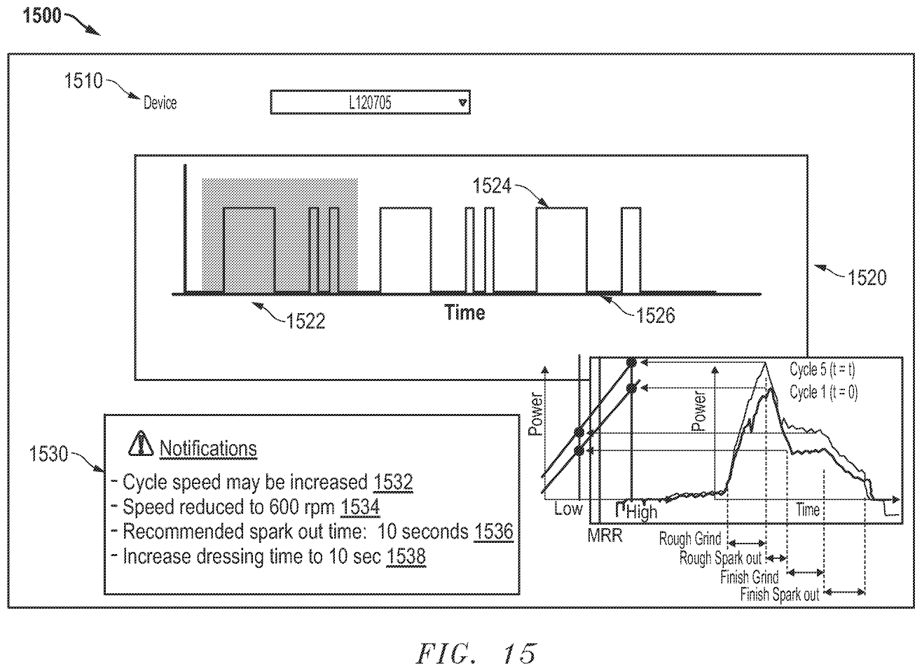

Analytics platform 1110 may also include statistical process control panel 1400, a consumer facing package that may be used by enterprise 1120 to document and analyze variations in a process, device, device part, etc. FIG. 14 illustrates statistical process control panel 1400, according to an example embodiment. Statistical process control panel 1400 may include the following functionalities, among others: (1) provide alerts to when a defined signal has undesirable trends (as defined by the consumer), (2) document variations within a job/process, device, device part, etc., (3) analyze variations from job to job, device part to device part, etc., (4) analyze variations from device to device for the same job/part, (5) detecting anomalies in general and more specifically, in grinding cycles by using unsupervised machine learning algorithms, (6) detect variations from abrasive wheel to abrasive wheel variation (if information is available), (7) use of dynamic time warping for finding clusters to establish baselines in grinding assessment tests, which may include utilizing the tacit knowledge of the application engineer together with unsupervised machine learning algorithms, (8) use of online statistical process control evaluation in real time for grinding parameters, and (9) use of symbolic techniques for pattern mining across time series signals for grinding data. Statistical process control panel 1400 may also incorporate data acquired from metrology equipment and/or data acquired from vision systems (e.g. cameras) to predict the quality of parts. These additional analytics and/or tools may provide contextual data for unsupervised learning.

For simplicity, statistical process control panel 1400 may provide fewer than all of the functionalities described herein, including analyzing variations from device to device with the same part and providing alerts when a defined signal has undesirable trends. Similar to previous examples, a user using statistical process control panel 1400 may indicate the specific job, process, device, etc. to be monitored (in this case, a user may select a job and a property) using field 1410 and field 1412, and additional fields to be monitored may be added using button 1414. Plot 1420 may display the properties being monitored through key 1422, line 1424, and line 1426 and may document variations within the process, noting perhaps that the temperature is rising as time continues in this example.

Statistical process control panel 1400 may also provide alerts to when a defined signal has undesirable trends, as defined by the user (from enterprise 1120). Panel 1440 may furnish options to set, and the settings may be displayed on plot 1420 as reference. For example, the user may use panel 1440 to request a notification when the temperature of job RG1 is greater than 90 C and when the temperature of job RG2 is greater than 90 C. As reference, plot 1420 may display a line at 90 C to indicate the threshold or level at which a notification may be sent. The notification may be sent to remote devices 1128 (e.g. a mobile device of a member of enterprise 1120), in this scenario, to notify the user that the device on the job is overheating. Alternatively or additionally, statistical process control panel 1400 may display the notification, as in panel 1430.

Statistical process control panel 1400 may also include additional functionalities that are not illustrated. For example, statistical process control panel 1400 may have the ability to analyze variations from job to job, device part to device part, etc. and the ability to analyze variations from device to device for the same job/part. Field 1410 and field 1412 may be selectably adjusted to include such options and variations that may be displayed in plot 1420. Variations may be manually analyzed or using a computer algorithm. For example, enterprise 1120 may have an expected pattern for a process in a file accessible by statistical process control panel 1400 and statistical process control dashboard may compare measured points and expected points. Additionally, or alternatively, statistical tests, e.g. linear regression, student t-test, chi-squared test, analysis of variance (ANOVA), among others may be used to determine variance. Similar methods may be used to detect variations from abrasive wheel to abrasive wheel.

Another possible functionality in statistical process control panel 1400 may be detecting anomalies in general but also more specifically, in grinding cycles using statistical algorithms mentioned above or using supervised and/or unsupervised machine learning algorithms. Statistical process control panel 1400 may additionally include ability to perform, using unsupervised machine learning algorithms in combination with knowledge from an application engineer, dynamic time warping to find clusters to establish baselines in grinding assessment tests. Unsupervised machine learning algorithms may include dynamic time warping, use of confidence interval bands for controlling family wise error rate and symbolic representation aggregate approximation of time series data. Other examples are also possible. As an input, the unsupervised machine learning algorithm applied here may use data collected from sensors in the environment of a machine, on abrasive products 1122, on wearable devices 1124, etc. As an output, the unsupervised machine learning algorithm may classify the inputs in a manner that may be related to the anomaly (e.g. temperature is abnormal, RPM is higher on these machines, etc.).

Statistical process control panel 1400 may additionally include the ability to use online statistical process control evaluations in real time for grinding parameters and use of symbolic techniques for pattern mining across time series signals for grinding data. The computations for this data may be at the edge level (e.g. distributed among one or multiple of server devices 1116 and/or server devices 1126) or web based to achieve process control. Online statistical process control evaluations may be integrated into statistical process control panel 1400. Symbolic techniques may include symbolic representation aggregate approximation of time series data. Similar to above, algorithms on symbolic techniques for pattern mining may be stored in analytics system 1112 and upon request, the algorithms may be retrieved and relevant data may be retrieved from database devices 1114 by server devices 1116. Server devices 1116 may analyze the data and output the result to statistical process control panel 1400.

### X. Cycle Optimization Panel

Analytics platform 1110 may also include cycle optimization panel 1500, which may include (1) an analysis module that displays sensor data across various phases of producing a single part or between multiple parts, which may facilitate analysis of trends in part production quality, (2) a system to predict the remaining useful wheel life prior to wheel replacement/dressing based on current sensor data, (3) a module that determines the optimum feed rate and part cycle time across multiple machines in order to minimize wheel wear and associated costs, and functions including (1) reduce air time vs spark time, (2) reduce cycle time by optimizing feeds and speeds, (3) provide feedback on cycle time by optimizing feeds and speeds (automatic), (4) recommend proper sparkout time, and (5) increase parts/dress.

As mentioned above, cycle optimization panel 1500 may include an analysis module displaying sensor data across multiple parts, facilitating the analysis of trends in part production quality. The sensor data may be collected from multiple sensors across multiple machines across multiple enterprises, or any variation thereof (e.g. one type of machine across multiple enterprises, one type of sensor across multiple machines of one enterprise, etc.). The analysis module may be a line plot, similar to plot 1240, plot 1340, and plot 1420, where each line is representative of a different part. From this data, a user in enterprise 1120 may determine trends in part production quality. For example, data may indicate that the thickness of a particular part being manufactured on one or multiple machines is increasing and the user in enterprise 1120 may determine that abrasive products 1122 on those one or multiple machines are being worn down. Based on this determination, a user may take appropriate action, e.g. replacing abrasive products 1122 with new abrasive products that are not worn down and more efficient at the tasks.

Cycle optimization panel 1500 may also include a system to predict the remaining useful wheel life prior to wheel replacement or dressing replacement based on current sensor data (e.g., received from any sensor or controller individually or in combination). For example, sensor data may measure the vibration of the wheel, and based on the signal detected and parameters obtained from the signal (e.g. amplitude, frequency, etc.), determine an estimated time period in which the wheel will be effective before needing a replacement or before needing to be redressed. The estimated time period may be a number (e.g. 1 month) or a time range (e.g. 20-30 days). Cycle optimization panel 1500 may display a notification on a computing device or a remote device (e.g. remote devices 1128) of enterprise 1120 when the time period ends.

Additionally, cycle optimization panel 1500 may include a module that determines the optimum feed rate and part cycle time across multiple machines in order to minimize wheel wear and associated costs in addition to optimizing the process to produce better quality parts and to reduce costs associated with rejected parts. Feed rate may refer to the rate at which materials enter into the cycle and/or the rate at which grinding wheels are set to operate for the cycle or part of cycle at hand. Part cycle time may refer to the time of each cycle at the rate specified by the optimum feed rate. The determination of the optimum feed rate and part cycle time may depend on past data collected from abrasive products 1122 or wearable devices 1124 of enterprise 1120. In some embodiments, this determination may additionally depend on data collected from other enterprises using similar cycles, which may be stored on database devices 1114. The manufacturing entity (e.g. the entity maintaining analytics platform 1110) may have access to the data stored in database devices 1114 and server devices 1116 may analyze the data to provide the requesting enterprise 1120 with a prediction.

FIG. 15 illustrates cycle optimization panel 1500, demonstrating some of the example functions, which may include (1) reducing air time verses spark time, (2) reducing cycle time by optimizing feeds and speeds, (3) providing feedback on cycle time and automatically optimizing feeds and speeds, (4) recommending proper sparkout times, and (5) suggesting increases in parts and/or dressing time. Cycle & grinding analytics panel may include field 1510, plot 1520, and notifications section 1530. Cycle optimization panel 1500 is one example arrangement and many other arrangements including arrangements incorporating other features may be possible.

A user may use field 1510 to select a device or machine of which to view the cycle & grinding analytics. Plot 1512 may be an example plot of multiple manufacturing cycles, for example cycle 1522, incorporating air time and spark time. Air time may be the time that the grinding wheel is not in contact with a part being manufactured, an example of which is shown in plot 1512 as air time 1526. In contrast, spark time may be the time that the grinding wheel is in contact with a part, an example of which is shown in plot 1520 as spark time 1524. Reducing air time verses spark time may reduce the amount of time that the grinding wheel is being used while maintaining the same quality of product produced, which may be useful to increase the lifetime of the respective grinding wheel. In some examples, various processes could reduce both air time and spark time while maintaining part quality. Such processes may increase or decrease grinding wheel life. However, productivity may certainly improve with increased part throughput.

As mentioned above, functions of cycle optimization panel 1500 may also include reducing cycle time by optimizing feeds and speeds, providing feedback on cycle time and automatically optimizing feeds and speeds, recommending proper sparkout times, and suggesting increases in parts per dress (number of parts made between each dress) and/or suggesting time reductions relating to dressing wheels. An example of the output of these functions is illustrated in notifications section 1530. In some examples, such changes may also be reflected at a display of the given abrasion system. For example, line 1532 provides a suggestion that cycle speed may be increased for a more efficient process, which provides feedback on cycle time. Reducing cycle time by optimizing feeds and speeds may be useful to reduce the time it takes for each part to be manufactured. Similarly, notifications section 1530 may indicate that the feeds and speeds were automatically optimized, as in line 1534, which indicates that the speed was reduced to 600 rpm. Feeds may refer to the speed at which material is fed into the process and speeds may refer to the speed at which parts are manufactured. Notification section 1530 also recommends proper sparkout times, as in line 1536, which recommends that the sparkout time be 10 seconds. Sparkout times may indicate the time period or time at which the grinding wheel is in contact with the material being manufactured. In line 1536, sparkout time may refer to the time period that is needed to remove all of the material to ensure part tolerances are met. During sparkout, an abrasive wheel is in contact with the workpiece. Sparkout is normally used to remove material that was not removed due to deflection of machine elements. Notification section 1530 may also include line 1538, which suggests an increase in dressing time to 10 sec. It will be understood that notification section 1530 could include a decrease in dressing time. Notably, notification section 1530 is provided as an example, other possibilities incorporating or removing aspects of notification section 1530 may also be possible.

Functions of cycle optimization panel 1500 may be deduced and/or obtained using present and past data from database devices 1114 of just data from the enterprise, e.g. enterprise 1120, or also incorporating data from other enterprises using analytics platform 1110. As in previous examples, database devices 1114 may provide the necessary data to server devices 1116 and analytics system 1112 may provide the necessary algorithms to server devices 1116. At server devices 1116, the data may be analyzed according to the algorithms and/or models provided and conclusions may be displayed on cycle optimization panel 1500.

Wheel herein may refer to a grinding wheel and wheel replacement may refer to replacing the grinding wheel. Additionally, dressing replacement may refer to dressing or re-dressing the grinding wheel, which may be a process used to even the surface of grinding wheels and/or removing particle buildup from the grinding wheel.

### XI. Abrasive Product Sales Panel

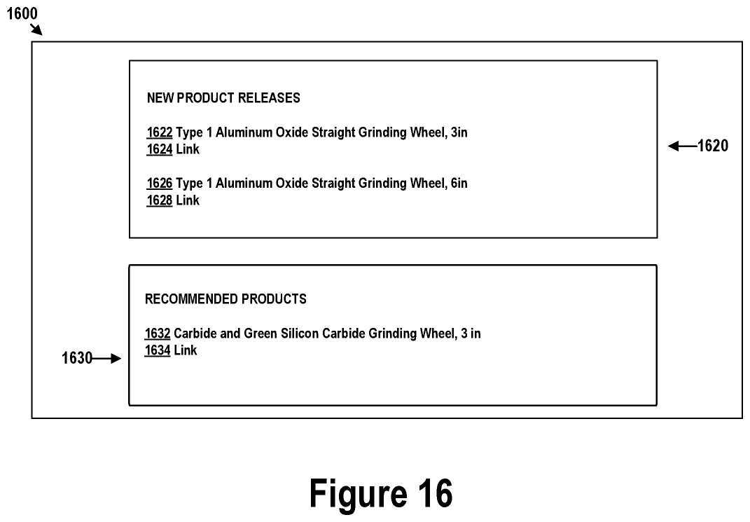

Analytics platform 1110 may additionally include abrasive product sales panel 1600, which may include an introduction of new abrasive products, link to the manufacturing entity's catalog, and product recommendations based on application conditions. FIG. 16 illustrates an example of abrasive product sales panel 1600, in accordance with example embodiments. Abrasive product sales panel 1600 incorporates new product release section 1620 and recommended products section 1630. In practice, abrasive product sales panel 1600 may incorporate a variety of other elements and other functions and abrasive product sales panel 1600 is only one example of such a panel. Other arrangements are possible.

New product release section 1620 of abrasive product sales panel 1600 may incorporate lines 1622, 1624, 1626, and 1628. Lines 1622 and 1626 may have the names of the new product being released and lines 1624 and 1628 may have the links to the products on the manufacturing entity's website on the respective product. In some examples, lines 1624 and 1628 may be incorporated into the names in lines 1622 and 1626. In other examples, lines 1624 and 1628 may be incorporated into other aspects of new product release section 1620, e.g. in an image of the product, and perhaps as well as in the names. Additionally, proper use conditions for each new product may be displayed in new product release section 1620. New product release section 1620 is one example of a section containing new product releases and many other examples/arrangements are also possible.

Recommended products section 1630 of abrasive product sales panel 1600 may incorporate lines 1632 and 1634. Line 1632 may have the name of the recommended abrasive product and line 1634 may have the link leading to the manufacturing entity's page on the respective product. Similar to new product release section 1620, the link of line 1634 may be incorporated into the name of the recommended abrasive product on line 1634, in an image of the recommended abrasive product, both, or other ways. These products may be recommended to the respective enterprise, e.g. enterprise 1120, based on data collected from the devices of enterprise 1120, e.g. wearable devices 1124 and remote devices 1128. An algorithm or predictive model from analytics system 1112 may be used to obtain the recommended products. The recommended products may be stored on database devices 1114 or other device of the manufacturing entity. Recommended products may be inferred upon receiving new data and recommendations stored in database devices 1114. Alternatively, recommended products may be inferred upon request from a user to display abrasive product sales panel 1600. Additionally, proper use conditions for each recommended product may be displayed in recommended products section 1630. Similar to new product release section 1620, recommended products section 1630 is one example of a section containing recommended products section 1630 and many other examples/arrangements are also possible.

### XII. Vibration and Chatter Panel

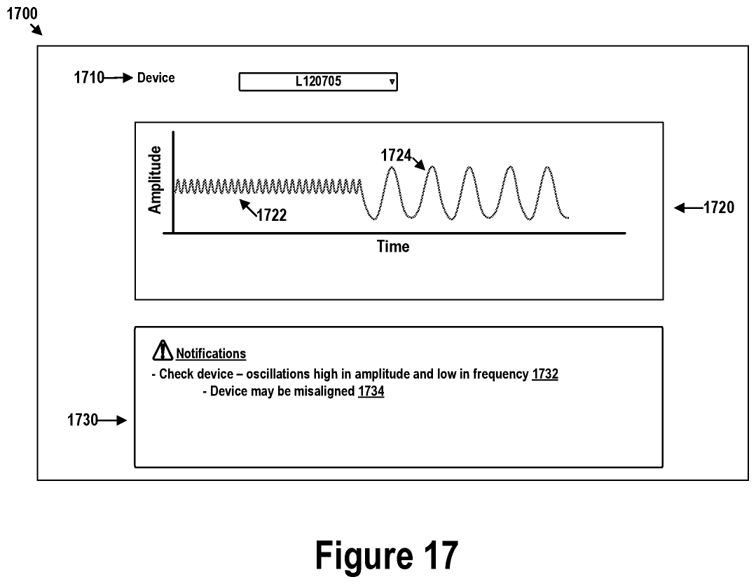

Analytics platform 1110 may additionally include vibration & chatter panel 1700, which may generally focus on vibration issues. In some situations, detecting and deriving conclusions from vibrations may be important to detect wheel related issues, e.g. cracks in the wheel, which could injure operators and other individuals in the proximity. Additionally, vibration & chatter panel 1700 may aid users in early detection of problems in a machine as a whole or a part of a machine. More specifically, vibration & chatter panel 1700 may involve the following features: (1) solving wheel imbalance issues, (2) identifying problems with automatic wheel balancers, (3) identifying types of chatter, (4) identifying natural frequency of spindle/wheel assembly, (5) monitoring vibration spectra and comparison to historical (good) cycle data, and (6) identifying wheel spindle bearing problems. Additionally, vibration & chatter panel 1700 may display vibrations that are detected in other parts of the machine (e.g. ball-screws). FIG. 17 illustrates an example of vibration & chatter panel 1700, which may include field 1710, plot 1720, and notifications section 1730.

Field 1710 may indicate the machine being displayed on vibration & chatter panel 1700 and plot 1720 may be data collected from that machine displayed on vibration & chatter panel 1700. Plot 1720 may have two regions, region 1722 and region 1724. Region 1722 may be of high frequency and low amplitude oscillations, whereas region 1724 may be of relatively lower frequency and lower amplitude oscillations. In some examples, region 1722 may be the oscillation collected from a grinding wheel operating under normal conditions, the oscillations being from noise collected from the grinding wheel. Region 1724, in contrast, may be abnormal oscillation, such as when the grinding wheel is not properly aligned. It may be noted that region 1724 would likely contain oscillations similar to region 1722 modulated onto the wave in region 1724, but for the purpose of simplicity, this modulation is not displayed. Additionally, signals in regions 1722 and 1724 may be approximate and shown as examples; actual signals collected from devices such as abrasive products 1122 and wearable devices 1124 may differ accordingly.

Notifications section 1730 may display notifications based on information deduced from the signal in plot 1720, including line 1732 and line 1734, which may be examples of monitoring vibration spectra in comparison to historical cycle data and identifying wheel imbalance issues (which may then be solved), respectively. Line 1732 notifies the user to check the device that oscillations may have changed from normal oscillations to oscillations that are high in amplitude and low in frequency. Line 1734 indicates that the device may be misaligned. These notifications may be shown on vibration & chatter panel 1700 or alternatively may be displayed on one of remote devices 1128. On remote devices 1128, the user may be asked if they would like to automatically realign the wheel to correct for imbalance issues.

The algorithm and/or model used to identify that the wheel is misaligned may additionally be used to identify problems with automatic wheel balancers. For example, the algorithm may identify that there is a balance problem and use an automatic wheel balancer to correct the problem. Then, the algorithm may be used in a loop to identify if a similar balance problem remains after use of an automatic wheel balancer, correct accordingly, and repeat the process.

Vibration spectra obtained from data shown in plot 1720 may continuously or periodically be monitored to ensure that there are no issues relating to vibration, which, as stated above, may be hazardous to operators or other individuals in the proximity. Vibration data may be periodically be sent to server devices 1116 and analyzed for the frequency and amplitude. To determine the frequency, a Fast Fourier Transform may be applied to sections of the vibration data. To determine amplitude, the algorithm may determine peaks and subtract the local minimas from the local maximas. Other algorithms are also possible. The natural frequency of the vibration may be monitored and each data segment may be compared to the previously reported segments. Abnormalities may be determined and reported to an operator/user of the machine and/or automatically fixed.

### XIII. Dressing Panel

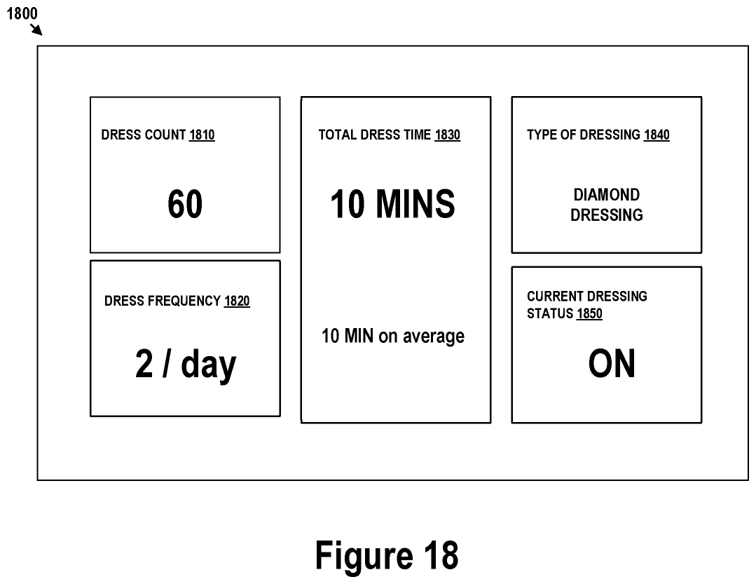

Analytics platform 1110 may also include dressing panel 1800 (illustrated in FIG. 18), which may involve calculating dressing analytics, such as dress count, dress frequency, total dress time, number of parts produced between each dress, total amount of wheels dressed, wheel life estimator based on dress count, and indicator of dressing, etc. FIG. 18 illustrates one example of dressing panel 1800, in accordance with example embodiments. Dressing panel 1800 may include dress count section 1810, dress frequency section 1820, total dress time section 1830, type of dressing section 1840, and current dressing status section 1850. Other operations and regions are possible.

Dress count section 1810 may include the total dress count of a specific grinding stone and/or machine, in this case 60 dressings. Dress frequency section 1820 may indicate the number of dressings done per day, in this case 2 per day. Alternatively, dress frequency section 1820 could include the number of parts made between each dress. Total dress time section 1830 may include the total dress time, in this case 10 minutes. Other statistics may also be calculated, in this case, total dress time section 1830 also includes that on average, each dressing took 10 minutes. Type of dressing section 1840 may include the type of dressing, in this case, diamond dressing is used. Current dressing status section 1850 includes whether the wheel and/or the wheel on a particular machine is currently being dressed, which, in this case, it is. In some examples, the amount of dressing time and number of dressings may be kept at a minimum. Furthermore, dressing feed, speeds, dress ratios, etc., can be optimized and/or recommended.

Dress count section 1810, dress frequency section 1820, total dress time section 1830, type of dressing section 1840, and current dressing status section 1850 may be automatically and periodically set based on past statistics and the displayed data may be deduced from sensors on abrasive devices 1122. Alternatively, these sections may each be fields changeable by the operator of the machine.

### XIV. Wheel Life Panel

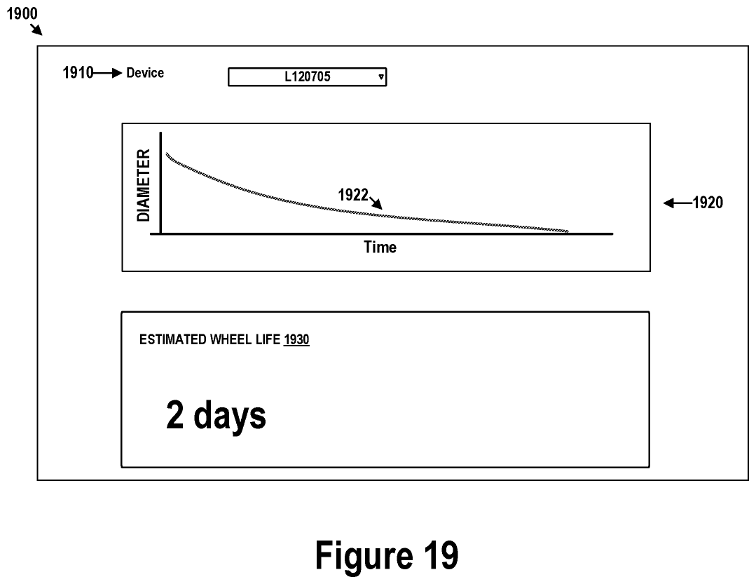

Analytics platform 1110 may additionally include wheel life panel 1900, which may include (1) a system to predict the remaining useful wheel life prior to wheel replacement or dressing based on current sensor data, and (2) a module to estimate wheel life using dress frequency, dress amount per pass, and part throughput. FIG. 19 illustrates wheel life panel 1900, in accordance with example embodiments. Wheel life panel 1900 may include field 1910, plot 1920, and estimated wheel life region 1930. Wheel life panel 1900 is just one example arrangement, many other arrangements incorporating other features mentioned herein or removing the features of wheel life panel 1900 are also possible. Additionally, wheel life panel 1900 may be a software package without a user interface.

Field 1910 may be used by a user to select the machine and/or wheel corresponding to a given wheel life. Plot 1920 may be a plot of the collected diameters of the wheel across time, or of other data of the wheel across time that may be used in the system to predict the remaining useful wheel life prior to wheel replacement or dressing based on current sensor data. For example, plot 1920 may be used to determine the remaining useful wheel life, where line 1922 of the diameter of the wheel is just above the threshold. Other data may also be used to predict the remaining useful wheel life and time until the next dressing (e.g. the number of parts processed, with the current wheel before dressing, vibration data as mentioned in vibration & chatter panel 1700.

Wheel life panel 1900 may also include a module to estimate wheel life using dress frequency, dress amount per part, and part throughput and the estimated wheel life may be displayed in estimated wheel life region 1930. Dress frequency, dress amount per part, and part throughput may include data collected from sensors on abrasive products 1122 and/or from sensors on wearable devices 1124.

### XV. Wheel Management Panel

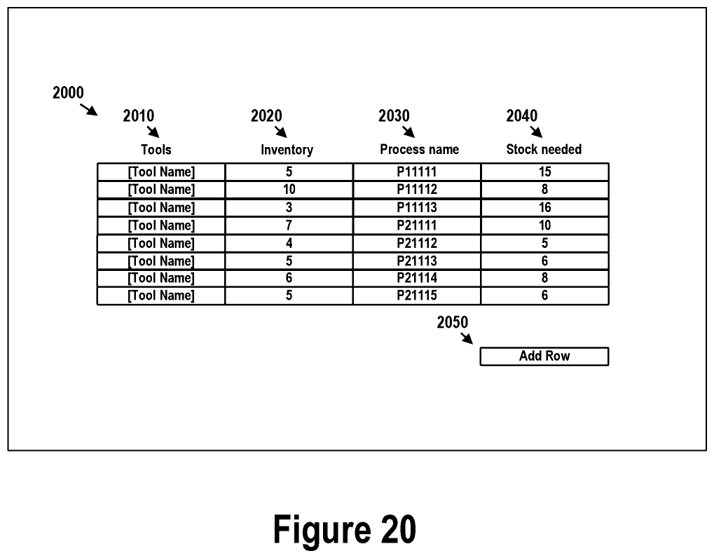

Analytics platform 1110 may additionally include wheel management panel 2000 (illustrated in FIG. 20), which may be used to build up a simple database of tool inventory levels and analytics to show usage data. In some embodiments, information about wheel life could come from RFID, QR codes, bar codes, or another indicator. Then, the approximate stock needed for current job cycles may be determined through predictive analysis. Wheel management panel 2000 may have tools name column 2010, inventory column 2020, process name column 2030, stock needed column 2040, and button 2050. Other arrangements of wheel management panel 2000 are possible.

Tools name column 2010 may be a manual entry column with the tool name or tool names that are being managed. Inventory column 2020 may contain entries with numbers representative of the number of tools that are stock, corresponding to the respective tool name from tool name column 2010. Process name column 2030 may contain entries corresponding to the process name in which the corresponding tool in tools name column 2010 is being used. Stock needed column 2040 may contain entries that take into account the respective entries in tools name column 2010, inventory column 2020, and process name column 2030 to display the estimated stock needed for current job cycles. The stock needed may be additional stock needed or stock needed in total.

Tools name column 2010, inventory column 2020, and process name column 2030 may be entered into wheel management panel 2000 manually and stock needed column 2040 may be automatically populated based on the manual entry. Alternatively, either or both of inventory column and process name column may be populated automatically. The automatic population of columns may use data from database devices 1114 or predictive algorithms from analytics system 1112.

Wheel management panel 2000 may also include other features, for example, analytics concerning the use of a tool over time by machine, by day, etc. These features may be incorporated as a plot similar to plots of previously discussed panels. Additionally, features of wheel management panel 2000 may be integrated in the other panels or features from other panels may be integrated in wheel management panel 2000.

### XVI. Bellwether Analytics Panel

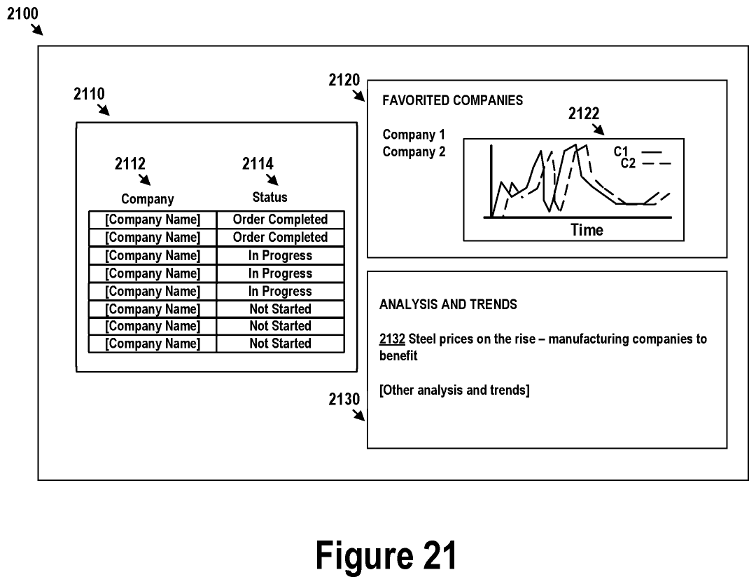

Analytics platform 1110 may additionally include bellwether analytics panel 2100 which may include features including (1) providing current status of all companies, (2) predicting trends, (3) monitoring several preferred companies, and (4) providing market based analysis and trends. FIG. 21 illustrates bellwether analytics panel 2100, according to example embodiments. Bellwether analytics panel includes status region 2110, monitoring region 2120, and analysis and trends region 2130. Other arrangements of bellwether analytics panel 2100 are also possible.

Status region 2110 may include a chart with company name column 2112 and status column 2114 to facilitate providing current status of all companies. Company name column 2112 may have the name of the company and status column 2114 may have the status of the orders for the corresponding company from company name column 2112. Other properties corresponding to the status of the company may also be monitored, for example the outlook of the company as a whole, the stock price of the company if it is publically listed, etc. Additionally, these properties and other properties may be an addition to the chart of status region 2110 or an alternative to status column 2114. This data may be stored in database devices 1234 and retrieved upon request (e.g. when the user requests to see bellwether analytics panel 2100).

Monitoring region 2120 may contain plot 2122 among other items to monitor favorited companies. Companies may be indicated as favorited in status region 2110 or selected in a field of monitoring region 2120 and the property corresponding to “favorited” may be stored in database devices 1234 so that a similar panel with updated details may be loaded each time the user requests. Plot 2122 may be a plot indicating the status of the favorited companies, e.g. the outlook of the company, number of parts ordered, the stock price of the company if it is publically listed, etc. Monitoring region 2120 may include other items and additional information useful to monitoring the favorited companies.

Analysis and trends region 2130 may provide market based analysis and trends and may provide predicted future trends, as analyzed from data stored in database devices 1234. The trends may be predicted using algorithms from analytics system 1112 and computed through the use of server devices 1116. In analysis and trends region 2130, line 2132 provides an example trend. Other trends and predictions are possible.

Generally, bellwether analytics panel 2100 may be provided to the manufacturing entity to monitor the status of the companies who use their devices and incorporating data from database devices 1114 across all enterprises using the products produced by the manufacturing entity. In other examples, however, bellwether analytics panel 2100 may be provided to enterprise 1120 to monitor the companies that use the products of enterprise 1120. Data may be stored on a database device of enterprise 1120 or on a database device of the manufacturing entity (e.g. database devices 1114).

### XVII. Machine Health Panel

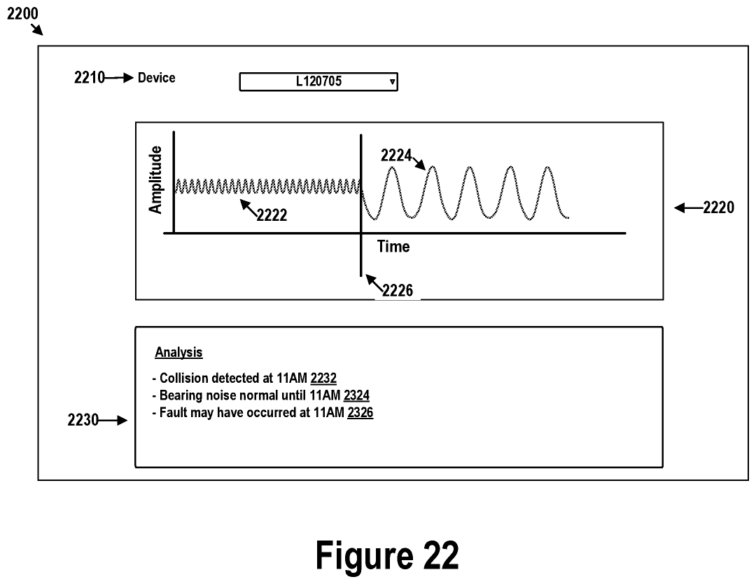

Analytics platform 1110 may additionally include machine health panel 2200 which may have features including analysis of faults, collision detection and bearing noise. Machine health panel 2200 may incorporate, in whole or in part, features of vibration & chatter panel 1700. FIG. 22 illustrates machine health panel 2200, in accordance with example embodiments. Machine health panel 2200 may include field 2210, plot 2220, and analysis region 2230, but may contain other features mentioned herein in other arrangements.

Field 2210 may indicate the device and/or machine and plot 2220 may show the bearing noise and/or collision detection. Plot 2220 includes region 2222 and region 2224, where the signal in each region differs in amplitude and in frequency and both of which may be representative of bearing noise. Additionally, plot 2220 includes line 2226 indicating the time at which a collision may have occurred.

Analysis region 2230 may provide information on the collision detection, bearing noise, and analysis of faults through lines 2232, 2234, and 2236, respectively. Line 2234 may provide information that a collision was detected and at what time, as indicated by line 2226. Line 2324 may provide information on the bearing noise and line 2326 may provide information on the fault.

Machine health panel 2200 may aid users in assigning a status to the machine, for example, whether the machine needs repairs, what repairs the machine may need, whether the machine should continue to be used, whether the machine is safe to be used, and so on. These analytics may be derived from data stored in database devices 1114 and algorithms/models corresponding to analytics system 1112. These analytics may help users in using the machine in a safe and reliable manner. In some examples, the machine health panel 2200 could indicate problems/issues with specific machine elements either through predictive methodologies and/or by way of status reports. In other words, the machine health panel 2200 could be configured to predict when failures may occur and recommend taking action prior to actual failures.

### XVIII. Economics Panel

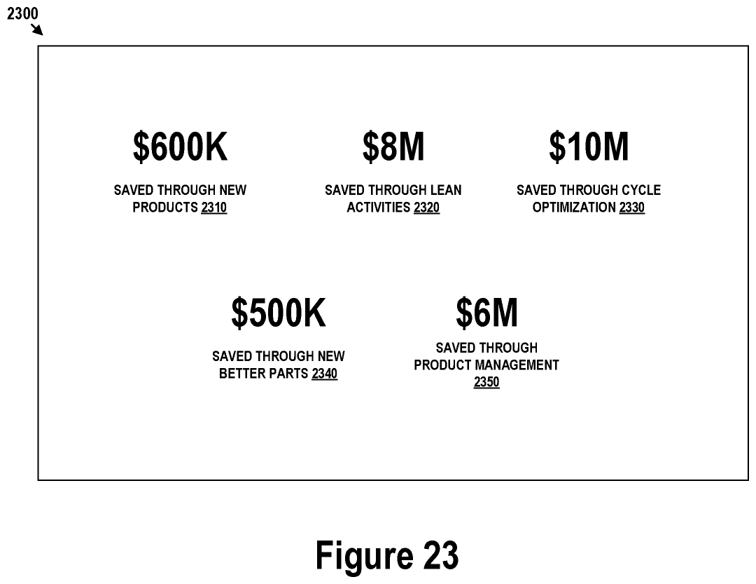

Analytics platform 1110 may additionally include economics panel 2300, which may have features including (1) showing cost reductions through new product sales, (2) showing cost reduction due to lean activities, (3) showing cost reduction due to cycle optimization, (4) showing cost reduction due to better parts, and (5) showing cost reduction due to project management. FIG. 23 illustrates economics panel 2300, in accordance with example embodiments. Economics panel 2300 may include region 2310, region 2320, region 2330, region 2340, and region 2350, but other examples are possible, e.g. those that may incorporate additional regions with additional features.

Region 2310 may include a number associated with the monetary amount that was saved through the integration of new products, such as the new products that were recommended in recommended products section 1630 of abrasive product sales panel 1600. Region 2320 may contain a number associated with the monetary amount saved through lean activities, such as reducing waste. Region 2330 may contain a number associated with the monetary amount saved through cycle optimization, such as the suggestions provided in cycle optimization panel 1500. Region 2340 may include a number associated with the monetary amount saved through utilization of better parts, for example, through using better products as recommended by recommended products section 1630 of abrasive product sales panel 1600. Region 2350 may include a number corresponding to a monetary amount saved through product management, following the suggestions and analysis provided in the panels mentioned in analytics panel 1118.

The data of regions 2310, 2320, 2330, 2340, and 2350 may be derived from statistics stored in database devices 1114 using algorithms associated with analytics system 1112 and analyzed on server devices 1116, similar to other panels. As stated above, economics panel 2300 may conclusions based on actions taken by enterprise 1120 based on suggestions provided by one or more of the panels in analytics panel 1118.

### XIX. Distributed Manufacturing Panel

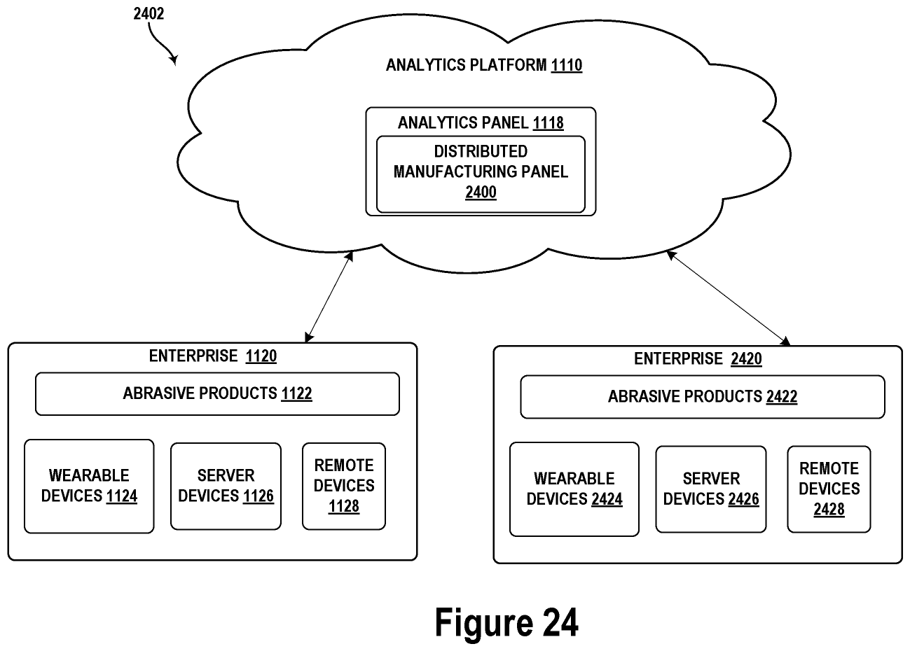

Analytics platform 1110 may additionally include distributed manufacturing panel 2400, which may feature the ability to distribute work among different companies based on customer demand. FIG. 24 may be of arrangement 2402 incorporating distributed manufacturing panel 2400. Arrangement 2402 may have analytics platform 1110, enterprise 1120, and enterprise 2420. Enterprises 1120 and 2420 and distributed manufacturing panel 2400 of analytics panel 1118 are shown for the purposes of example and other arrangements are also possible. For example, arrangements may incorporate one or more enterprises as well as one or more panels. In practice, the features of distributed manufacturing panel 2400 may be incorporated with features of other panels as well as arrangement 2402 differing based on the situation.

As mentioned above, distributed manufacturing panel may feature the ability to distribute work among different companies based on customer demand. In some examples, enterprise 1120 may be manufacturing a product using abrasive products 1122 and wearable devices 1124. Sensors associated with abrasive products 1122 and wearable devices 1124 may collect the data and a computing device associated with the sensors may send the data to analytics platform 1110. Analytics platform 1110 may analyze the data using features of distributed manufacturing panel 2400 and determine that the machines of enterprise 1120 do not have the capability to do the amount of orders within a timeframe. Distributed manufacturing panel may display a notification to enterprise 1120 and ask if they would like to shift some of the manufacturing to enterprise 2420, which may have similar abrasive products 2422 and similar wearable devices 2424. If so, distributed manufacturing panel 2400 may display the process and/or manufactured part needed. The distribution of work from enterprise 1120 may be distributed to one or more other enterprises that have similar abrasive products 2422 and similar wearable devices 2424 to enterprise 1120.

### XX. Environmental Health and Safety Optimization Panel

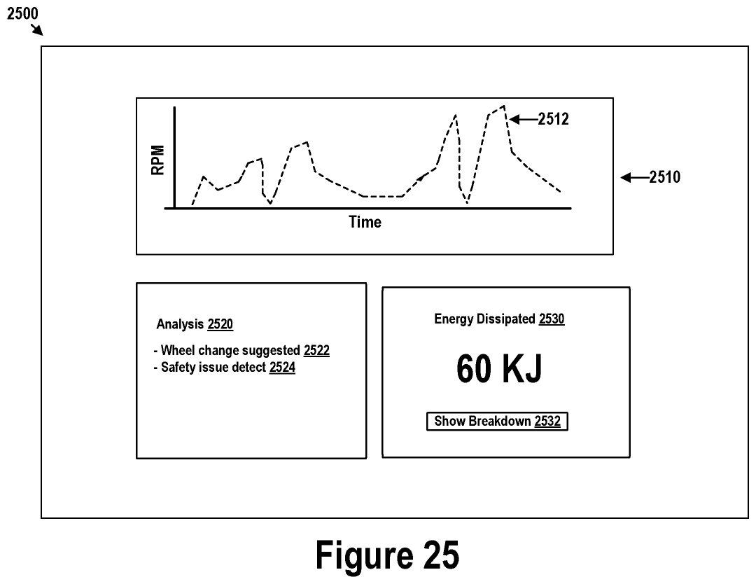

Analytics platform 1110 may additionally include environmental health and safety optimization panel 2500, which may have features including (1) looking for energy and material waste in the grinding process, (2) using real time data from production to enable the efficient allocation of materials and energy, (3) improving efficiency through changing wheel specification or employing a different dressing tool, (4) showing energy input and output and breakdown of the energy used in the manufacturing process, and (5) alerting users of safety issues. FIG. 25 illustrates environmental health and safety optimization panel 2500, in accordance with example embodiments. FIG. 15 may include plot 2510, analysis region 2520, and energy dissipated region 2530. Other examples are possible.

Plot 2510 may be a plot of signal 2512 of real time data collected during production during the use of abrasive devices 1122 and wearable devices 1124. The plotted real time data may be used to enable the efficient allocation of materials and energy. For example, the revolutions per minute (RPM) towards the later half of signal 2512 increased from the RPM towards the start of the signal. Accordingly, features and algorithms associated with safety optimization panel 2500 may indicate that more energy should be allocated towards the process at the end of the signal and/or indicate that the wheel should be redressed for efficiency.

Analysis region 2520 may contain suggestions, such as in lines 2522 and 2524. Line 2522 may indicate that a wheel change is suggested and line 2524 may indicate that a safety issue was detected. A user or operator of the machine may take appropriate action following these suggestions. These suggestions may facilitate environmental health through higher efficiency in the long run in addition to facilitating in protecting operators from injuries on the manufacturing floor.

Energy dissipated region 2530 may include the amount of energy dissipated and button 2532. The amount of energy dissipated may be calculated from the energy input and energy output and this information may be shown upon the user selecting button 2532. Alternatively, the energy input and output may be shown directly on environmental health and safety optimization panel 2500.

As in previous panels of analytics platform 1110, information in environmental health and safety optimization panel 2500 may be derived from information in database devices 1114 using algorithms/models in analytics system 1112 and computed in server devices 1116. The analyzed information may be useful to enterprise 1120 to make more informed decisions on the health and safety of their machines.

### XXI. Remote Application Engineering Panel

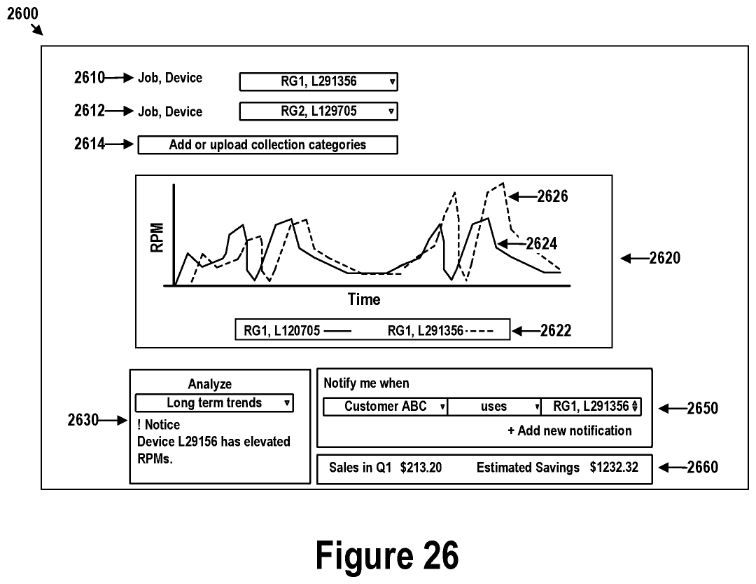

In addition to the other panels, analytics platform 1110 may include remote application engineering panel 2600 (illustrated in FIG. 26) for the entity maintaining analytics platform 1110 and directly or indirectly manufacturing abrasive products 1122 or wearable devices 1124. Remote application engineering dashboard 2600 may include all functionality of cycle and grinding analytics panel 1300 (e.g. the ability to select different areas of a signal and calculate necessary information and the ability to superimpose all signals and manipulate graphs) as well as provide application engineers with behavioral statistics on customers. Some example functionalities may include (1) collecting operating conditions via customer input or file upload, (2) showing cost reductions through new product sales, (3) analyzing long term trends within a job, comparisons between job to job, etc. and get alerts for selected customer operations, (4) calculating and storing parameters (material removal rate, chip thickness, material removal during sparkout, among other functionality.

Remote application engineering panel 2600 may include collecting operating conditions via customer input or file upload (through using field 2610, field 2612, and button 2614), a display of the conditions (through plot 2620), analysis panel 2630, notification panel 2650, and display 2660 indicating new sales and estimated savings. Field 2610 and field 2612 may be based on information provided by customers of the manufacturing entity (e.g. members of enterprise 1120). These customers may indicate on their devices to automatically report data or otherwise send data to the entity in the form of a data file (e.g. files ending in .data, .xlxs, .csv, .tsv, etc.). Additional operating conditions may be uploaded through button 2614.

This data of operating conditions may be displayed in remote application engineering panel 2600 in plot 2620, which includes key 2622, line 2624, and line 2626. Similar to previous examples, it may be deduced through key 2622 that line 2624 is derived from field 2610 and that line 2626 is derived from field 2612. For simplicity, plot 2620 displays only two lines from two fields, however, plot 2620 may display many more fields or only one field, depending on the situation and use.

Remote application engineering panel 2600 may also include panel 2630 to analyze long term trends and provide feedback to the maintaining entity. In this example, one device performing a job may display elevated rotations per minute (RPM) to achieve the same results as another device. Accordingly, panel 2630 may indicate that device RG2 has elevated RPMs. An application engineer may use this indication as notice that one abrasive product might be wearing out more quickly than another and suggest that another abrasive product be used.

Notification panel 2650 may also be included in remote application engineering panel 2600 such that the manufacturing entity may receive notifications of certain customer operations. For example, an application engineer may determine that the RPM of device 29156 is dangerous and set a notification for if and when the customer uses the device. A notification may be sent to a remote device of the manufacturing entity.

Remote application engineering panel 2600 may also include display 2660 indicating new sales and estimated savings, among other potential sales related statistics. Other functionality not displayed in remote application engineering panel 2600 may also be possible, for example the ability to calculate and store parameters (material removal rate, chip thickness, material removal during sparkout. MRR may be calculated according to a process outlined above. Additionally, remote application engineering panel may also have functions to facilitate calculating parameters based on the application and/or application specific tool boxes.

Many different aspects and embodiments are possible. Some of those aspects and embodiments are described herein. After reading this specification, skilled artisans will appreciate that those aspects and embodiments are only illustrative and do not limit the scope of the present invention. Embodiments may be in accordance with any one or more of the embodiments as listed below.

Embodiment 1. A computer-implemented method, comprising:
receiving, at the computing device, sensor data from one or more sensors, wherein the one or more sensors are disposed in proximity to an abrasive product or a workpiece associated with the abrasive product, wherein the one or more sensors are configured to collect abrasion operational data associated with an abrasive operation involving the abrasive product or the workpiece; performing at least one of the following operations:
   (i) receiving, at the computing device, a user input indicating an organization of data;
      determining, based on the sensor data, a machine downtime report;
      based on the user input, organizing the machine downtime report; and determining, from the sensor data, an operator efficiency report;
   (ii) in response to receiving the sensor data, determining an operation metrics report; and
   (iii) selecting data organization types
   (iv) receiving, at the computing device, a user input indicating a data organization type wherein the data organization type includes by machine, by operator, or by process;
      determining, based on the sensor data and a data organization type, a setup time report; and
   (v) determining, based on the sensor data, a shift variation report, wherein the shift variation report provides information indicative of metric variations across a plurality of work shifts; and
   (vi) determining, based on the sensor data, a machine comparison report, wherein the machine comparison report provides information indicative of similar processes occurring on different machines; and
displaying, on the computing device, at least one displayed report, wherein the displayed report comprises at least one of the downtime report, the operation metrics report, a setup time report, a shift variation report, or a machine comparison report.

Embodiment 2. The method of embodiment 1, wherein the operations further comprise comparing the operational metrics report to predetermined metrics.

Embodiment 3. A computer-implemented method, comprising:
receiving, at the computing device, sensor data from one or more sensors, wherein the one or more sensors are disposed in proximity to an abrasive product or a workpiece associated with the abrasive product, wherein the one or more sensors are configured to collect abrasion operational data associated with an abrasive operation involving the abrasive product or the workpiece;
performing at least one of the following operations:
   (i) displaying, on the computing device, a cycle chart plotting at least one grinding cycle corresponding to a time range or a machine; and displaying, at the computing device, the cycle chart;
   (ii) determining, based on the sensor data, a grinding cycle report relating to the analysis of at least one portion of a grinding cycle; and displaying, at the computing device, the grinding cycle report;
   (iii) determining, based on the sensor data, a computed metric report having values of various metrics, wherein the values include an average and at least one local maxima; and
      displaying, at the computing device, the computed metric report.

Embodiment 4. The method of embodiment 3, wherein displaying further includes at least one of the following:
(i) determining, at the computing device, past sensor data received at the computing device;
   displaying, at the computing device, the past sensor data;
   receiving an user input indicative of changing a view of the past sensor data; and
   displaying the changed view of the past sensor data responsive to the user input;
(ii) determining, at the computing device, patterns or values corresponding to an operational error over a predetermined period of time; and displaying the operational error;
(iii) receiving, at the computing device, data corresponding to a user input;
   determining, from the sensor data and data corresponding to the user input, cost reductions achieved through at least one of process optimization and troubleshooting; and displaying the cost reductions.

Embodiment 5. A computer-implemented method, comprising:
receiving, at the computing device, sensor data from one or more sensors, wherein the one or more sensors are disposed in proximity to an abrasive product or a workpiece associated with the abrasive product, wherein the one or more sensors are configured to collect abrasion operational data associated with an abrasive operation involving the abrasive product or the workpiece;
performing at least one of the following operations:
   (i) determining, based on the sensor data, a variation report, wherein the variation report includes information indicative of a variation within a process or a workpiece; and
      displaying, on the computing device, the variation report;
   (ii) determining, based on the sensor data, an anomaly report, wherein the anomaly report includes information indicative of anomalies within a process using at least one unsupervised machine learning method; and displaying, on the computing device, an output report, wherein the output report comprises the variation report or the anomaly report.

Embodiment 6. The method of embodiment 5, wherein the at least one unsupervised machine learning methods are at least one of dynamic time warping, use of confidence interval bands for controlling family wise error rate, and symbolic representation aggregate approximation.

Embodiment 7. A computer-implemented method, comprising:
receiving, at the computing device, sensor data from one or more sensors, wherein the one or more sensors are disposed in proximity to an abrasive product or a workpiece associated with the abrasive product, wherein the one or more sensors are configured to collect abrasion operational data associated with an abrasive operation involving the abrasive product or the workpiece;
performing at least one of the following operations:
   (i) displaying, on the computing device, a plurality of datasets from the sensor data; and
      determining a part production quality trend;
   (ii) determining, based on sensor data, a grinding wheel life, wherein
      grinding wheel life corresponds to an amount of time prior to redressing or a wheel replacement is needed; and
      displaying, on the computing device, the grinding wheel life;
   (iii) determining, based on the sensor data, an optimum feed rate and an part cycle time, wherein a machine configured to use the optimum feed rate and part will minimize grinding wheel wear; and
      displaying, on the computing device, at least one of the optimum feed rate and the part cycle time;
   (iv) determining, based on the sensor data, a sparkout time; and
      displaying, on the computing device, the sparkout time.

Embodiment 8. A computer-implemented method, comprising:
receiving, at the computing device, sensor data from one or more sensors, wherein the one or more sensors are disposed in proximity to an abrasive product or a workpiece associated with the abrasive product, wherein the one or more sensors are configured to collect abrasion operational data associated with an abrasive operation involving the abrasive product or the workpiece;
determining, based on the sensor data, at least one of: a product recommendation list or process recommendations; and
displaying, on the computing device, the product recommendation list or the process recommendations.

Embodiment 9. A computer-implemented method, comprising:
receiving, at the computing device, sensor data from one or more sensors, wherein the one or more sensors are disposed in proximity to an abrasive product or a workpiece associated with the abrasive product, wherein the one or more sensors are configured to collect abrasion operational data associated with an abrasive operation involving the abrasive product or the workpiece;
determining, based on sensor data, a natural frequency associated with a grinding wheel or a part of a grinding wheel;
determining, based on sensor data, a frequency associated with the grinding wheel or part of a grinding wheel; and
determining whether an issue exists with the grinding wheel by comparing the natural frequency and the frequency.

Embodiment 10. The method of embodiment 9, further comprising applying an automatic wheel balancer on the grinding wheel if the issue is determined to exist.

Embodiment 11. The method of embodiment 10, further comprising:
upon applying the automatic wheel balancer, determining, based on sensor data, the frequency associated with the grinding wheel or part of a grinding wheel; and
determining whether an issue exists with the grinding wheel by comparing the natural frequency and the frequency.

Embodiment 12. A computer-implemented method, comprising:
receiving, at the computing device, sensor data from one or more sensors, wherein the one or more sensors are disposed in proximity to an abrasive product or a workpiece associated with the abrasive product, wherein the one or more sensors are configured to collect abrasion operational data associated with an abrasive operation involving the abrasive product or the workpiece; and
determining, based on the sensor data, at least one of the following: a dress count, a dress frequency, a total dress time, wheel life remaining, number of parts per dress, and an indicator of dressing.

Embodiment 13. A computer-implemented method, comprising:
receiving, at the computing device, sensor data from one or more sensors, wherein the one or more sensors are disposed in proximity to an abrasive product or a workpiece associated with the abrasive product, wherein the one or more sensors are configured to collect abrasion operational data associated with an abrasive operation involving the abrasive product or the workpiece;
determining, based on sensor data, a grinding wheel life, wherein grinding wheel life corresponds to an amount of time prior to redressing or a wheel replacement is needed; and
displaying, on the computing device, the grinding wheel life.

Embodiment 14. The method of embodiment 13, wherein determining the grinding wheel life is further based on dress count, dress amount for a manufactured part, and a throughput of the manufactured part.

Embodiment 15. A computer-implemented method, comprising:
receiving, at the computing device, sensor data from one or more sensors, wherein the one or more sensors are disposed in proximity to an abrasive product or a workpiece associated with the abrasive product, wherein the one or more sensors are configured to collect abrasion operational data associated with an abrasive operation involving the abrasive product or the workpiece;
determining a tool inventory database;
determining, based on the sensor data, usage data of one or more tools in the tool inventory database; and
determining an approximate additional number needed of the one or more tools.

Embodiment 16. A computer-implemented method, comprising:
receiving, at the computing device, sensor data from one or more sensors, wherein the one or more sensors are disposed in proximity to an abrasive product or a workpiece associated with the abrasive product, wherein the one or more sensors are configured to collect abrasion operational data associated with an abrasive operation involving the abrasive product or the workpiece;
performing at least one of the following operations:
   (i) determining one or more company statuses;
      designating, based on one or more user inputs, one or more companies as favorited companies; and
      displaying one or more updates corresponding to the one or more favorited companies;
   (ii) determining one or more market trends; and
      displaying the one or more market trends.

Embodiment 17. A computer-implemented method, comprising:
receiving, at the computing device, sensor data from one or more sensors, wherein the one or more sensors are disposed in proximity to an abrasive product or a workpiece associated with the abrasive product, wherein the one or more sensors are configured to collect abrasion operational data associated with an abrasive operation involving the abrasive product or the workpiece;
performing at least one of the following operations:
   (i) determining, based on the sensor data, a fault analysis;
   (ii) determining, based on the sensor data, one or more collisions;
   (iii) determining, based on the sensor data, bearing noise; and
   (iv) predicting any of the above steps and transmitting at least one recommendation.

Embodiment 18. A computer-implemented method, comprising:
receiving, at the computing device, sensor data from one or more sensors, wherein the one or more sensors are disposed in proximity to an abrasive product or a workpiece associated with the abrasive product, wherein the one or more sensors are configured to collect abrasion operational data associated with an abrasive operation involving the abrasive product or the workpiece;
determining, based on the sensor data, a cost reduction, wherein the cost reduction corresponds to one of the following changes: one or more purchases of one or more new products or one or more changes in cycle optimizations; and
displaying the cost reduction.

Embodiment 19. A computer-implemented method, comprising:
receiving, at the computing device, sensor data from one or more sensors, wherein the one or more sensors are disposed in proximity to an abrasive product or a workpiece associated with the abrasive product, wherein the one or more sensors are configured to collect abrasion operational data associated with an abrasive operation involving the abrasive product or the workpiece; and
determining, based on sensor data and information stored in a database, whether to distribute work among one or more additional enterprises.

Embodiment 20. A computer-implemented method, comprising:
receiving, at the computing device, sensor data from one or more sensors, wherein the one or more sensors are disposed in proximity to an abrasive product or a workpiece associated with the abrasive product, wherein the one or more sensors are configured to collect abrasion operational data associated with an abrasive operation involving the abrasive product or the workpiece;
performing at least one of the following operations:
   (i) determining, based on the sensor data, efficiency improvements; and displaying, on the computing device, the efficiency improvements;
   (ii) determining, based on the sensor data, energy input and energy output; and
      displaying, on the computing device, the energy input and the energy output;
   (iii) determining, based on the sensor data, abnormal vibrations; and
      displaying, on the computing device, a suggested action in response to the abnormal vibrations.

1-15. (canceled)

16. A computer-implemented method, comprising:
receiving, at a computing device, sensor data from one or more sensors, wherein the one or more sensors are disposed in proximity to an abrasive product or a workpiece associated with the abrasive product, wherein the one or more sensors are configured to collect abrasion operational data associated with an abrasive operation involving the abrasive product or the workpiece;
performing at least one of the following operations:
(i) displaying, on the computing device, a cycle chart plotting at least one grinding cycle corresponding to a time range or a machine; and
displaying, at the computing device, the cycle chart;
(ii) determining, based on the sensor data, a grinding cycle report relating to analysis of at least one portion of a grinding cycle; and
displaying, at the computing device, the grinding cycle report; or
(iii) determining, based on the sensor data, a computed metric report having values of various metrics, wherein the values include an average and at least one local maxima; and
displaying, at the computing device, the computed metric report.

17. The method of claim 16, comprising determining the grinding cycle report relating to analysis of at least one portion of the grinding cycle; and displaying, at the computing device, the grinding cycle report, wherein the grinding cycle report comprises spark time and air time related to the abrasive product.

18. The method of claim 17, further comprising reducing air time verses spark time of the abrasive product, reducing air time and spark time of the abrasive product, or both.

19. The method of claim 17, further comprising performing at least one of the following operations:
(i) reducing grinding cycle time by optimizing feeds and speeds for the abrasive product;
(ii) providing feedback on grinding cycle time and automatically optimizing feeds and speeds for the abrasive product;
(iii) recommending proper sparkout times related to the abrasive product;
(iv) suggesting increases in parts per dress for the abrasive product; or
(v) suggesting time reductions relating to dressing the abrasive product.

20. The method of claim 17, comprising displaying, on the computing device, a cycle chart plotting at least one grinding cycle corresponding to a time range or a machine; and displaying, at the computing device, the cycle chart.

21. The method of claim 17, further comprising determining part cycle time across a plurality of machines.

22. The method of claim 21, wherein determining part cycle time comprises using present and past sensor data.

23. The method of claim 21, further comprising determining, at the computing device, past sensor data received at the computing device; and displaying, at the computing device, the past sensor data.

24. The method of claim 23, further comprising receiving an user input indicative of changing a view of the past sensor data; and displaying the changed view of the past sensor data responsive to the user input.

25. The method of claim 16, further comprising performing at least one of the following operations:
(i) displaying, on the computing device, a plurality of datasets from the sensor data; and
determining a part production quality trend;
(ii) determining, based on the sensor data, an optimum feed rate and an part cycle time, wherein a machine configured to use the optimum feed rate and part will minimize grinding wheel wear; and
displaying, on the computing device, at least one of the optimum feed rate and the part cycle time;
(iii) determining, based on the sensor data, a sparkout time; and
displaying, on the computing device, the sparkout time.

26. The method of claim 16, comprising displaying, on the computing device, a cycle chart plotting at least one grinding cycle corresponding to a time range or a machine; and displaying, at the computing device, the cycle chart.

27. The method of claim 16, comprising performing the following operation: determining, based on the sensor data, the computed metric report having values of various metrics, wherein the values include an average and at least one local maxima; and displaying, at the computing device, the computed metric report.

28. The method of claim 16, comprising performing at least one of the following operations:
(i) determining, at the computing device, patterns or values corresponding to an operational error over a predetermined period of time; and
displaying the operational error; or
(ii) receiving, at the computing device, data corresponding to a user input;
determining, from the sensor data and data corresponding to the user input, cost reductions achieved through at least one of process optimization and troubleshooting; and
displaying the cost reductions.

29. The method of claim 16, further comprising receiving, at the computing device, a user input indicating an organization of data; determining, based on the sensor data, a machine downtime report; based on the user input, organizing the machine downtime report; and determining, from the sensor data, an operator efficiency report; in response to receiving the sensor data, determining an operation metrics report; and selecting data organization types.

30. The method of claim 16, further comprising receiving, at the computing device, a user input indicating a data organization type wherein the data organization type includes by machine, by operator, or by process; determining, based on the sensor data and the data organization type, a setup time report; determining, based on the sensor data, a shift variation report, wherein the shift variation report provides information indicative of metric variations across a plurality of work shifts; and determining, based on the sensor data, a machine comparison report, wherein the machine comparison report provides information indicative of similar processes occurring on different machines; and displaying, on the computing device, at least one displayed report, wherein the displayed report comprises at least one of the downtime report, the operation metrics report, a setup time report, the shift variation report, or the machine comparison report.

31. A system, comprising:
a computing device configured to:
receive sensor data from one or more sensors, wherein the one or more sensors are disposed in proximity to an abrasive product or a workpiece associated with the abrasive product, wherein the one or more sensors are configured to collect abrasion operational data associated with an abrasive operation involving the abrasive product or the workpiece;
determine, based on the sensor data, a grinding cycle report relating to the analysis of at least one portion of a grinding cycle; and
display, via a user interface, the grinding cycle report, wherein the grinding cycle report comprises spark time and/or air time related to the abrasive product.

32. The system of claim 31, wherein the computing device is configured to:
determine, based on the sensor data, a computed metric report having values of various metrics, wherein the values include an average and at least one local maxima; and
display, via the user interface at the computing device, the computed metric report.

33. The system of claim 31, wherein the computing device is configured to display, via the user interface, a cycle chart plotting at least one grinding cycle corresponding to a time range or a machine.

34. The system of claim 31, wherein the computing device is configured to determine an optimum feed rate, part cycle time across a plurality of machines, or both.

35. The system of claim 31, wherein the computing device is configured to display sensor data across various phases of producing a single part or between multiple parts.
